(19) United States
(12) Patent Application Publication
(10) Pub. No.: US 2024/0217835 A1
(43) Pub. Date: Jul. 4, 2024

(54) POROUS CUBIC SODIUM YTTRIUM FLUORIDE GELS, SYSTEMS, METHODS, AND MATERIALS THEREOF

(71) Applicants: Kevin LEE, Seattle, WA (US); Vincent HOLMBERG, Seattle, WA (US); University of Washington, Seattle, WA (US)

(72) Inventors: Alexander Bard, Seattle, WA (US); Kevin Guesang Lee, Seattle, WA (US); Greg Felsted, Seattle, WA (US); Vincent Holmberg, Seattle, WA (US); Peter Pauzauskie, Seattle, WA (US)

(73) Assignee: University of Washington, Seattle, WA (US)

(21) Appl. No.: 18/558,087

(22) PCT Filed: Apr. 29, 2022
(86) PCT No.: PCT/US2022/027047

§ 371 Date: Oct. 30, 2023

Related U.S. Application Data
(60) Provisional application No. 63/182,569, filed on Apr. 30, 2021.

(51) Int. Cl. C01F 17/36; H01M 4/58

(52) U.S. Cl. CPC C01F 17/36; H01M 4/582; C01P 2002/01; C01P 2002/72; C01P 2002/86; C01P 2004/04; C01P 2004/38; C01P 2006/12; C01P 2006/16; C01P 2006/40

(57) ABSTRACT

Systems, devices, materials, and methods including nanostructured gels are provided. A nanostructured gel includes a primary crystalline phase including cubic sodium yttrium fluoride, a secondary crystalline phase including cubic yttrium fluoride, and an amorphous phase including sodium ions and yttrium fluoride.

### CROSS-REFERENCE(S) TO RELATED APPLICATION(S)

This application claims the benefit of provisional application No. 63/182,569, filed on Apr. 30, 2021, entitled “Porous Cubic Sodium Yttrium Fluoride Gel,” the contents of which are hereby incorporated by reference in their entirety.

### STATEMENT OF GOVERNMENT LICENSE RIGHTS

This invention was made with Government support under National Science Foundation grant ECC-1542101, Office of Naval Research grant N00014-18-1-2370, Department of Energy, Office of Basic Science, Grant DE-AC05-76LO1830. The Government has certain rights in the invention.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a nanostructured gel includes a primary crystalline phase including cubic sodium yttrium fluoride, a secondary crystalline phase including cubic yttrium fluoride, and an amorphous phase including sodium ions and yttrium fluoride.

In some embodiments, an antireflective structure includes a transparent substrate and the nanostructured gel overlying the substrate.

In some embodiments, an energy storage device includes a working electrode, configured to reversibly store a charge carrier; a counter electrode; a separator interposed between the working electrode and the counter electrode; and an electrolyte disposed between the working electrode and the counter electrode and contacting the working electrode, forming at least a part of a conductive path for the charge carrier between the working electrode and the counter electrode, wherein the working electrode comprises a nanostructured gel of any of the preceding aspects.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic illustration of an example energy storage device incorporating a nanostructured gel, in accordance with embodiments of the present disclosure.

FIG. 2 is a schematic illustration of an example antireflective structure incorporating a nanostructured gel, in accordance with embodiments of the present disclosure.

FIGS. 3A-G describe synthesis of NaYF gel, in accordance with embodiments of the present disclosure. (A) a photo of solutions of 0.8M NaF and 0.2M YCl₃; (B) a photo of a gel formed by combining the solutions of FIG. 3A; (C) a photo of a filtrate dried to a translucent solid (scale bar=1 cm); (D) a transmission electron microscope (TEM) image of an interconnected structure in bright field TEM. (Scale bar=50 nm); (E) a scanning-transmission electron microscope (STEM) HAADF image of a piece of gel of FIG. 3C (Scale bar=100 nm); (F) a 3D reconstructed tomographic isosurface model of the same particle in FIG. 3E; (G) a reconstructed tomographic slice through a mid-line of the particle of FIG. 3E, showing interconnected, porous internal structure.

FIG. 4 is a sequence of images showing the formation of the gel of FIGS. 3A-G and a collapse into larger single nanocrystals over the course of hours.

FIG. 5 is a powder X-ray diffraction spectrum of the gel of FIG. 3C, showing measured XRD spectrum with spacings consistent with cubic NaYF or YF₃. The predicted peaks correspond to large crystals of α-NaYF that have formed from the gel.

FIGS. 6A-F describes microstructural characterization of the gel of FIG. 3D. (A) is a non-reconstructed crystal structure of cubic (a) NaYF; (B) is a crystal structure of cubic YF₃; (C) is a crystal structure of orthorhombic YF₃. Each structure shows 2×2 unit cells to emphasize empty space in the structure of FIG. 6B. (D) is a bright field high resolution TEM image of the gel showing both ordered and disordered regions, overlaid with a fast Fourier transform of the labeled ordered region showing it to be cubic NAYF preferentially aligned along the 110 zone axis, with slight misalignment. (Scale bar=5 nm for the TEM and 5 nm-1 for the FFT) *NOTE: TEM image has been filtered to satisfy figure publication requirements, but order information is preserved; (E) a mapping showing 111 d-spacing measured by FFT, with d-spacings shown by shaded markers overlaid on a TEM image. Smaller d-spacings correspond to a unit cell closer to NaYF₄ and larger d-spacings correspond to a unit cell closer to YF₃. Scale bar=10 nm (F) STEM-EDS spectrum showing the elemental analysis. Note the lack of any significant Cl peak. Cu is residual from the TEM grid.

FIGS. 7A-C present results of TEM imaging and in situ crystallization of gels of the present disclosure. Standard TEM/SAED experiments on the gel in vacuum induced significant crystallization in the gel, as shown by the sharper rings in the SAED patterns. There is no significant change to the morphology of the particles during that time.

FIG. 8 is a histogram of measured d-spacings in FIG. 6E in the 111 range.

FIGS. 9A-C describe results of an ion replacement experiment using NaYF gels, in accordance with embodiments of the present disclosure. (A) is a schematic diagram illustrating the cation replacement experiment; (B) is a representative XRD spectrum at a time of t_{inc}=60 minutes, highlighting a region of 022 peaks for KY₃F₁₀ and NaYF₄; (C) is a graph of peak height data as a function of incubation time for the 022 peaks corresponding to either KY₃F₁₀ or NaYF₄ normalized to the sum of the 022 peak heights for both phases as a function of incubation time (t_{inc}). The 022 peak was chosen due to its relatively high intensity as well as the relatively low convolution of the two peaks at that 20. The plot in FIG. 9C illustrates that the longer the gel is allowed to develop in its native solution prior to filtration, the more sodium is retained by the final product, and the less potassium is incorporated.

FIGS. 10A-H describe results of NMR experiments of 19F solid state NMR comparing gels of the present disclosure with α-NaYF and orthorhombic YF3 standards at 55 C. (A) is a TEM image with SAED data (bottom inset); (B) is a dark field TEM image of single-crystalline α-NaYF from the gel. The dark field TEM indicates that the whole particle is single crystalline. Scale bar=400 nm for the TEM and 5 nm-1 for the SAED; (C) is a crystalline structure of the α-NaYF crystal; (D) is a TEM image of orthorhombic YF₃ synthesized in a similar, organic-free method; (E) is a crystal structure diagram for orthorhombic YF₃ crystal. Scale Bar=100 nm (F) is a ¹⁹F spin-echo MAS NMR spectra of the gel, YF₃, and α-NaYF at a spinning speed of 32 kHz and an interpulse delay of 31.25 μs (one rotor cycle). The asterisks (*) indicate the spinning sidebands; (G) ¹⁹F T₂-filtered NMR spectra of the gel in accordance with embodiments of the present disclosure, YF₃, and α-NaYF after eight π-pulses with an interpulse delay of 65.2 μs (two rotor cycles). (H) ¹⁹F inverse-recovery normalized signal intensity (markers) vs. interpulse delay of gel, YF₃, and α-NaYF as well as the fits (lines) for obtaining the spin-lattice relaxation time constant T₁.

FIGS. 11A-H are simulation results of Cahn-Morral modeling of gel synthesis. Separation of Na, Y, F, and Cl ions based on the Cahn-Morral equation and their initial concentrations. (A)-(D) Separation of ions at select points over time shown in both two dimensions and one dimension. The one-dimensional plots measure along the horizontal edge of the two-dimensional plots. Time is calculated by measuring an average domain size of 10.708 nm and relating it to a diffusion coefficient of 1.4×10-5 cm2s-1. Scale bar=10 nm. (E)-(H) Evolution of partial composition for each ion, darker colors indicate earlier time points. Note the smaller y axis for the Y plot.

FIG. 12 is a graph of laser refrigeration data for 10% Yb3+ doped NaYF gel, in accordance with embodiments of the present disclosure, showing a decrease in temperature of up to 0.55° C. as a 1020 nm diode laser power is increased from 1 mW to 25 mW. Laser refrigeration measurements were performed by attaching a gel sample to an optical fiber mounted inside an optical cryostat (Janis ST500). The Yb³⁺ cations were excited with a 1020 nm diode laser (QPhotonics QFBGLD-1020-400) to induce luminescent upconversion, cooling the gel. The upconverted photoluminescence of the NaYF gel was collected at several different laser irradiances. The mean fluorescent wavelength for each spectrum was compared against calibrations at known temperatures to determine cooling efficiency.

FIG. 13 is a graph of performance data for an example energy storage device including nanostructured gels using lithium-ion charge carriers, in accordance with embodiments of the present disclosure. The graph illustrates specific capacity (left y-axis) and coulombic efficiency (right y-axis) as a function of cycle number for charging and discharging. Cycles 1-4 correspond to a C/20 rate. Cycles 5-8 correspond to a C/10 rate. Cycles 9-12 correspond to a 1 C rate.

FIGS. 14A-B are graphs of experimental data for the example energy storage device of FIG. 13, illustrating voltage as a function of specific capacity for charging and discharging in accordance with a C/20 charge/discharge rate (full charge or discharge in 20 hours). FIG. 14A illustrates charging curves and FIG. 14B illustrates discharging curves. With the exception of the first discharge cycle, the example energy storage device exhibited limited variation between cycles, indicating suitability of gels of the present disclosure as charge storage media.

FIGS. 15 A-B are graphs of experimental data for the example energy storage device of FIG. 13, illustrating voltage as a function of specific capacity for charging and discharging in accordance with a C/10 charge/discharge rate (full charge or discharge in 10 hours). FIG. 15A illustrates charging curves and FIG. 15B illustrates discharging curves. The example energy storage device exhibited limited variation between cycles, indicating suitability of gels of the present disclosure as charge storage media.

FIGS. 16A-B are graphs of experimental data for the example energy storage device of FIG. 13, illustrating voltage as a function of specific capacity for charging and discharging in accordance with a 1 C charge/discharge rate (full charge or discharge in 1 hour). FIG. 16A illustrates charging curves and FIG. 16B illustrates discharging curves. The example energy storage device exhibited limited variation between cycles, indicating suitability of gels of the present disclosure as charge storage media.

FIGS. 17A-B 13 are graphs of performance data for an example energy storage device including nanostructured gels using sodium ion charge carriers, in accordance with embodiments of the present disclosure. FIG. 17A illustrates specific capacity as a function of cycle number; FIG. 17B illustrates coulombic efficiency as a function of cycle number for charging and discharging. Cycles 1-4 correspond to a C/20 rate. Cycles 5-8 correspond to a C/10 rate. Cycles 9-12 correspond to a 1 C rate. In comparison to the data for lithium ion devices of FIG. 13, FIGS. 17A-B illustrate the suitability of gels of the present disclosure as charge storage media for multiple different charge carriers.

FIGS. 18A-B are graphs of experimental data for the example energy storage device of FIGS. 17A-B, illustrating voltage as a function of specific capacity for charging and discharging in accordance with a C/20 charge/discharge rate (full charge or discharge in 20 hours). FIG. 18A illustrates charging curves and FIG. 18B illustrates discharging curves. With the exception of the first discharge cycle, the example energy storage device exhibited limited variation between cycles, indicating suitability of gels of the present disclosure as charge storage media.

FIGS. 19A-B are graphs of experimental data for the example energy storage device of FIGS. 17A-B, illustrating voltage as a function of specific capacity for charging and discharging in accordance with a C/10 charge/discharge rate (full charge or discharge in 10 hours). FIG. 19A illustrates charging curves and FIG. 19B illustrates discharging curves. The example energy storage device exhibited limited variation between cycles, indicating suitability of gels of the present disclosure as charge storage media.

FIGS. 20A-B are graphs of experimental data for the example energy storage device of FIGS. 13, illustrating voltage as a function of specific capacity for charging and discharging in accordance with a 1 C charge/discharge rate (full charge or discharge in 1 hour). FIG. 20A illustrates charging curves and FIG. 20B illustrates discharging curves. The example energy storage device exhibited limited variation between cycles, indicating suitability of gels of the present disclosure as charge storage media.

In the above-referenced drawings, like reference numerals refer to like parts throughout the various views unless otherwise specified. Not all instances of an element are necessarily labeled to simplify the drawings where appropriate. The drawings are not necessarily to scale, emphasis instead being placed upon illustrating the principles being described.

### DETAILED DESCRIPTION

While illustrative embodiments have been illustrated and described, it will be appreciated that various changes can be made therein without departing from the spirit and scope of the invention.

Embodiments of the present disclosure include nanostructured gel materials and applications in energy storage and optical materials, in particular, relating to sodium-yttrium-fluoride crystalline materials and associated uses in energy storage devices using lithium, sodium, and fluoride ions as charge carriers, and/or in optical coatings.

Embodiments of the present disclosure include a four-step mechanism for aqueous synthesis of sodium yttrium fluoride (NaYF) involving 1) segregation of aqueous ions into a dense liquid phase, 2) formation of an amorphous aggregate, 3) nucleation of a cubic YF₃ phase, and 4) solid-state diffusion of sodium and fluoride ions to form a crystalline NaYF₄ phase. The final step involves a continuous, gradual change of the solid phase's chemical stoichiometry from YF₃ toward NaYF₄ with intermediate stoichiometries represented by:

Na_{0.5-x}Y_{0.5+x}F₂₊₂ₓ with 0<x<0.5

Unlike previously reported nucleation and growth mechanisms, the stoichiometry of the nanostructured solid phase evolves during the crystallization process rather than being determined at nucleation. The resulting material comprises multiple nonuniformly distributed crystalline and amorphous phases having nonstoichiometric composition in sodium, yttrium, and fluorine.

Advantageously, the nanostructured solid phase forms an open-cell pore structure including primary larger pores and secondary smaller pores. The pore structure improves mass and species transport properties for energy applications and serves to reduce reflections at the interface of an optical application, thereby improving transmission of incident photons through the interface, reducing scattering. Additionally, the (100) surface of NaYF exhibits a type 3 Tasker surface termination (with both a non-zero charge and a local dipole moment normal to the surface) that has been shown to generate a large number of nearly-degenerate surface reconstructions that may enhance mass transport across the solid-liquid interface. Furthermore, the pore structure exhibits a significantly increased surface area from 1-3 orders of magnitude higher specific surface area relative to conventional charge storage materials, measured in m²/g of material, which improves species and charge transport properties of the nanostructured solid phase significantly. As described below, the nanostructured solid phase can define cubic crystal structures of NaYF and YF₃ that exhibit improved ion transport properties relative to other crystal structures, based at least in part on the presence of ion channels that increase charged species diffusion rates. Due at least in part to the combination of porous structure, high surface area, and suitable crystal structure, conductance of fluoride ions by NaYF gels of the present disclosure were found to be on the order of 10⁻⁵ cm²/sec, approximately five orders of magnitude higher than alternative materials, such as YF₃.

The combination of advantageous properties and material characteristics permits NaYF materials of the present disclosure to be incorporated into various applications including energy storage devices as charge storage media, in optical elements as optically active films (e.g., antireflective coatings, optical cooling films, optical refrigeration materials, etc.), supercapacitors, ion separation columns, and photocatalysis.

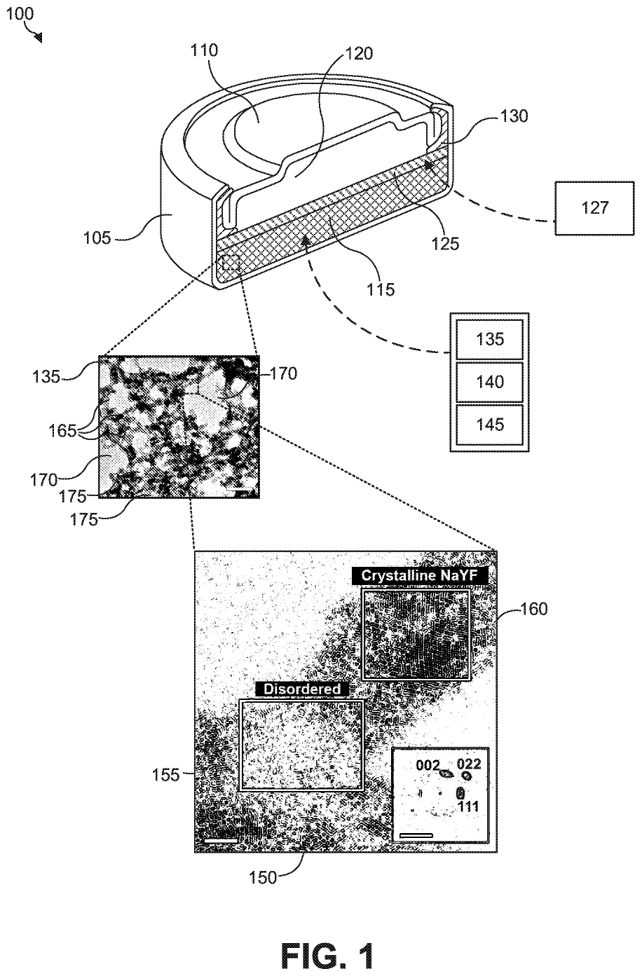

FIG. 1 is a schematic illustration of an example energy storage device 100 incorporating a nanostructured gel, in accordance with embodiments of the present disclosure. While example energy storage device 100 is illustrated as a coin cell battery, embodiments of the present disclosure include other form factors and configurations including but not limited to cylindrical, prismatic, and/or pouch cell batteries. Example energy storage device 100 includes a case 105 and a cap 110, together making up the external housing. Enclosed in the external housing, example energy storage device 100 includes paired electrodes, one of which acts as a working electrode 115 and the other as a counter electrode 120. In the illustration of FIG. 1, a single working electrode 115 and a single counter electrode 120 are shown. In some embodiments, energy storage devices include multiple working electrodes 115 and multiple counter electrodes 120, as in lithium pouch cells, for example, which can include many single cells that are electronically coupled to increase the total charge capacity of energy storage devices of the present disclosure. Interposed between the paired electrodes 115-120 is a separator 125, held in place by a gasket 130. Both separator 125 and gasket 130 are formed from materials that are electrochemically inert. Separator 125, however, incorporates microstructured and/or nanostructured features that permit it to conduct charge (e.g., pores and/or channels). Separator 125 is typically impregnated with an electrolyte 127 that facilitates charge transfer (e.g., electrons and/or ions) between the electrodes 115-120.

In some embodiments, working electrode 115 incorporates a nanostructured gel material 135 including cubic NaYF crystalline domains, as described in more detail in reference to Examples 1-2 below. In example energy storage device 100, the nanostructured gel 135 serves as a charge storage medium that can be combined with a conductive additive 140 and a binder 145. Conductive additive 140 can be or include carbon-based materials, such as conductive carbon black, graphitic carbon (e.g., graphite, graphene, carbon nanotues, fullerenes, etc.), acetylene black, carbon nanofibures, or other forms of conductive carbon, as well as non-carbon based conductive additives including but not limited to metal fibers, metal powders, or the like. Binder 145 can be or include various organic compounds including, but not limited to carboxymethyl cellulose, sodium carboxymethyl chitosan, sodium alginate, polyvinylidene fluoride, polyacrylic acid, polytetrafluoroethylene, or (poly(3,4-ethylenedioxythiophene).

In some embodiments, the nanostructured gel 135 can be included in working electrode 115 in relative proportions to the other components 140-145 that provide improved performance as a charge storage medium. For example, as a proportion of the total weight of working electrode 115, nanostructured gel 135 can make up about 40%, about 45%, about 50%, about 55%, about 60%, about 65%, about 70%, about 75%, about 80%, about 85%, about 90%, or about 95%, including fractions and interpolations thereof, with components 140-145 making up the balance. For example, nanostructured gel 135 can make up about 64% of the working electrode 115 by weight. Based at least in part on the role of nanostructured gel 135 as a charge storage medium, the total storage capacity increases with increasing weight fraction of nanostructured gel 135 in working electrode 115. Conductive additive 140 serves an important role, however, by facilitate the formation of an active electrode/electrolyte interface between electrolyte 127 and nanostructured gel 135. Similarly, binder 145 material reinforces the structure of working electrode 115 and prevents thermal effects and other mechanical stresses from degrading the performance of example energy storage device 100. As such, a higher weight fraction of nanostructured gel 135 can reduce performance by inhibiting charge transfer from electrolyte 127, owing at least in part to the proportion of conductive additive 140 being below an optimum level.

In some embodiments, conductive additive 140 is included at a relative proportion of the total weight of working electrode 115 of about 40% or less, about 35% or less, about 30% or less, about 25% or less, about 20% or less, about 15% or less, about 10% or less, or about 5% or less, including fractions and interpolations thereof. In an illustrative example, working electrode can include about 64% by weight of nanostructured gel 135, about 20% by weight of conductive additive 140, and about 15% by weight of binder. In this context, the term “about” is used to indicate a value within 5% above or below the stated value. As such, about 64% includes values from 59% to 69%.

Nanostructured gel material 135 can include one or more crystalline phases 150 and one or more amorphous phases 155, as described in more detail in reference to Example 1, below. Crystalline phases 150 can include a primary crystalline phase 160 including cubic sodium yttrium fluoride, and a secondary crystalline phase of cubic yttrium fluoride. In some embodiments, based at least in part on the synthesis method employed for forming nanostructured gel 135, nanostructured gel 135 can be substantially free of organic solvents, capping ligands, or counterions conventionally used for the growth of NaYF gels, as described in more detail in reference to Examples 1-2. In this context, the term “substantially free” is used to indicate a possible non-zero composition of organic solvents, capping ligands, or counterions resulting, for example, from contamination during synthesis, purification, and/or other processing, but where such materials are not included as part of each process. Advantageously, the absence of such organic materials improves performance of nanostructured gel 135 as a charge storage medium by reducing interfacial layers between nanostructured gel 135, conductive additive 140, and/or electrolyte 127, as well as reducing electrochemical reactions involving organic molecules that can impair the performance of example energy storage device 100.

As described above, cubic NaYF of nanostructured gel 135 can be characterized by nonstoichiometric composition NaₓY_{y}F_{z}, where x is a number in the range of 0-1, y is a number in the range of 0-1, and z is a number in the range of 0-4. In some embodiments, a single parameter, “x” can be used to define the structure of crystalline phases 150 using the expressions Na_{0.5-x}Y_{0.5+x}F₂₊₂ₓ, where 0<x<0.5. At x=0.5, the composition represents the stoichiometry of YF₃, or yttrium trifluoride. Where x=0, the composition represents the stoichiometry of NaYF₄, as such, the structure can be represented by the non-stoichiometric composition (0.5−x)NaF·(0.5+x)YF₃.

In some embodiments, nanostructured gel 135 includes multiple gel particles 165, aggregated to form an open-cell porous structure including multiple primary pores 170 and multiple secondary pores 175. Primary pores 170 are larger than secondary pores 175. As primary pores 170 and secondary pores 175 can be nanostructured (e.g., having a largest characteristic dimension equal to or smaller than about 100 nm), pore sizes for nanostructure gel 135 are described in terms of a characteristic dimension. In some embodiments, primary pores 170 can have a characteristic dimension in the range of about 50 nm-to about 400 nm. In some embodiments, primary pores 170 have an average characteristic dimension of about 50 nm, about 55 nm, about 60 nm, about 65 nm, about 70 nm, about 75 nm, about 80 nm, about 85 nm, about 90 nm, about 95 nm, or about 100 nm, about 110 nm, about 120 nm, about 130 nm, about 140 nm, about 150 nm, about 160 nm, about 170 nm, about 180 nm, about 190 nm, about 200 nm, about 210 nm, about 220 nm, about 230 nm, about 240 nm, about 250 nm, about 260 nm, about 270 nm, about 280 nm, about 290 nm, about 300 nm, about 310 nm, about 320 nm, about 330 nm, about 340 nm, about 350 nm, about 360 nm, about 370 nm, about 380 nm, about 390 nm, or about 400 nm, including fractions and interpolations thereof. In this context, the term “about” is used to indicate a value within 5% above or below the stated value.

In contrast, secondary pores 175 can have a second characteristic dimension in the range of 0 nm-50 nm. As such, secondary pores 175 can have an average characteristic dimension of less than 1 nm, about 5 nm, about 10 nm, about 15 nm, about 20 nm, or about 25 nm, about 30 nm, about 35 nm, about 40 nm, about 45 nm, or about 50 nm, including fractions and interpolations thereof. In this context, the term “about” is used to indicate a value within 5% above or below the stated value.

The characteristic pore sizes of primary pores 170 and secondary pores 175 result at least in part from the synthesis method, described in reference to Examples 1-2, as well as the material properties of the nanostructured gel 135. As such, the open-cell pore structure of nanostructured gel 135 is understood not to be an inherent property of NaYF in general. Advantageously, the inclusion of primary pores 170 and secondary pores 175 improves the performance of nanostructured gel 135 in working electrode 115 relative to conventional charge storage media and/or alternative NaYF materials. For example, the inclusion of both large primary pores 170 and smaller secondary pores 175 provides improved charge and species transport through nanostructured gel 135, resulting in an improvement of ion conductance of almost five orders of magnitude, as described above. For example, nanostructured gel can exhibit an average ion conductance in liquid on the order of 10⁻⁶ cm⁻²/sec to 10⁻⁴ cm⁻²/sec, in contrast to a typical value of 10⁻¹¹¹ cm⁻²/sec to 10⁻⁹ cm⁻²/sec. In this context, the term “on the order of” in the instance of 10⁻⁵ cm⁻²/sec refers to values from 10⁻⁵ cm⁻²/sec to 10⁻⁴ cm⁻²/sec. As such, the average ion conductance in liquid can be about, 10⁻⁶ cm⁻²/sec, about 20⁻⁶ cm⁻²/sec, about 30⁻⁶ cm⁻²/sec, about 40⁻⁶ cm⁻²/sec, about 50⁻⁶ cm⁻²/sec, about 60⁻⁶ cm⁻²/sec, about 70⁻⁶ cm⁻²/sec, about 80⁻⁶ cm⁻²/sec, about 90⁻⁶ cm⁻²/sec, about 100⁻⁶ cm⁻²/sec, 10⁻⁵ cm⁻²/sec, about 20⁻⁵ cm⁻²/sec, about 30⁻⁵ cm⁻²/sec, about 40⁻⁵ cm⁻²/sec, about 50⁻⁵ cm⁻²/sec, about 60⁻⁵ cm⁻²/sec, about 70⁻⁵ cm⁻²/sec, about 80⁻⁵ cm⁻²/sec, about 90⁻⁵ cm⁻²/sec, about 100⁻⁵, 10⁻⁴ cm⁻²/sec, about 20⁻⁴ cm⁻²/sec, about 30⁻⁴ cm⁻²/sec, about 40⁻⁴ cm⁻²/sec, about 50⁻⁴ cm⁻²/sec, about 60⁻⁴ cm⁻²/sec, about 70⁻⁴ cm⁻²/sec, about 80⁻⁴ cm⁻²/sec, about 90⁻⁴ cm⁻²/sec, about 100⁻⁴ cm⁻²/sec, cm⁻²/sec, including fractions and interpolations thereof. In this context, the term “about” is used to indicate a value within 5% above or below the stated value.

Further, the open-cell pore structure increases the surface area of nanostructured gel 135, relative to other charge storage media, by as much as two orders of magnitude. For example, exhibits a characteristic specific surface area of approximately 1 m²/g, while nanostructured gel 135 can be characterized by a specific surface area in the range of 50-200 m²/g. In some embodiments, nanostructured gel 135 is characterized by an average specific surface area of about 50 m²/g, about 60 m²/g, about 70 m²/g, about 80 m²/g, about 90 m²/g, about 100 m²/g, about 110 m²/g, about 120 m²/g, about 130 m²/g, about 140 m²/g, about 150 m²/g, about 160 m²/g, about 170 m²/g, about 180 m²/g, about 190 m²/g, or about 200 m²/g, including fractions and interpolations thereof. In this context, the term “about” is used to indicate a value within 5% above or below the stated value.

As described in reference to Example 3, example energy storage device 100 can be configured to use various ions as charge carriers. For example, ion sources can be or include LiPF₄, NaClO₄, FeF₃, NaF, LiF, N,N,N-trimethyl-N-neopentylammonium fluoride (Np1F), and N,N,N-dimethyl-N,N-dineopentylammonium fluoride (Np2F) or other carriers that include or dissociate to produce lithium, sodium, and/or fluoride ions. In some embodiments, electrolyte 127 is selected to be suitable for use with lithium ions. In some embodiments, electrolyte 127 is selected to be suitable for use with sodium ions. Examples of suitable electrolytes include but are not limited to ethylene carbonate, dimethyl carbonate, ethyl methyl carbonat, diethylene carbonate, propylene carbonate, or combinations thereof. In some embodiments, electrolyte 127 is selected to be suitable for use with fluoride ions. Examples of suitable electrolytes for use with fluoride ions include but are not limited to aqueous or organic electrolytes, such as Bis(2,2,2-trifluoroethyl) ether (BTFE) or other halogenated ethers.

Similarly, separator 125 can be or include materials that are selected to be suitable for use with the charge carrier and/or electrolyte included in example energy storage device 100. For example, binder free grade GF/F borosilicate glass can be used, Other examples of separator 125 materials include but are not limited to ceramic blended polyethylene membrane, cellulose/polymer paper, ceramic/polymer coated polyolefin membranes, and/or nanofiber nonwoven membranes.

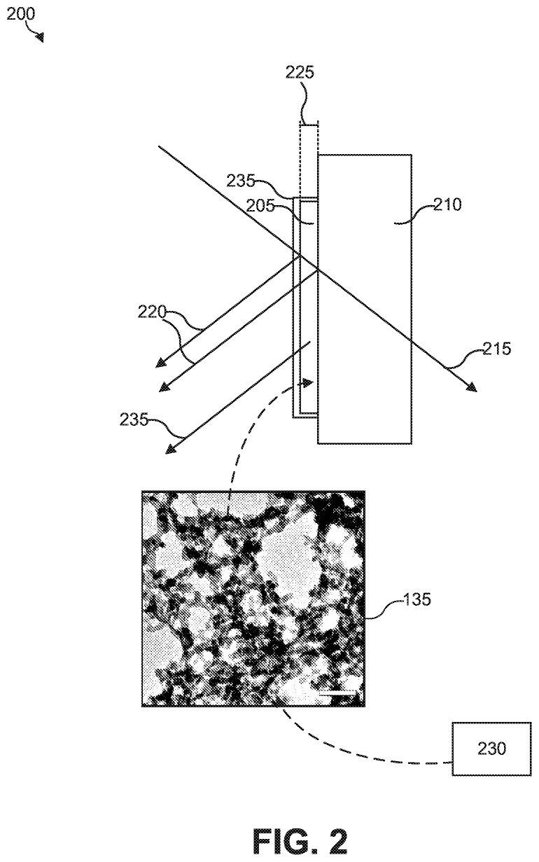

FIG. 2 is a schematic illustration of an example antireflective structure 200 incorporating a nanostructured gel 135, in accordance with embodiments of the present disclosure. The nanostructured gel 135 is described in more detail in reference to FIG. 1 and in exemplary embodiments in Examples 1-2. Embodiments described in reference to FIG. 2 focus on an antireflective structure, but it is contemplated that nanostructured gel 135 can be incorporated into other optical coatings including, but not limited to, coatings for optical cooling of substrates (e.g., optical fibers), coatings for high power fiber lasers, optical viewing windows into high-vacuum chambers, and both refractive and diffractive (i.e., Fresnel) lenses.

Example antireflective structure 200 includes a film 205 including nanostructured gel 135. Film 205 overlies at least a portion of transparent substrate 210. Transparent substrate 210 can be or include an optically transparent medium including, but not limited to optical glass, quartz, a polymer, or other transparent material. In this context, the term “transparent” refers to a medium that exhibits limited scattering of incident electromagnetic radiation 215. As such, “transparent” is understood to include translucent materials that exhibit scattering at interfaces, resulting in at least partial reflection of scattered radiation 220 at material interfaces of substrate 210. In this way, example antireflective structure 200 can be incorporated into different devices and systems that include an antireflective coating, including but not limited to transparent electronics, photovoltaic cells, optical lenses, optical windows into high vacuum chambers, or the like.

Film 205 can be deposited onto substrate 210 at a thickness 225 that is substantially equal to a quarter wavelength of incident radiation 215. In this context, the term “substantially” refers to tolerable deviations from a stated value resulting from fabrication processes, such as spin coating, evaporative deposition, sputtering, or the like, that deposit film 205 material with a nonzero error that is within system tolerances. Advantageously, depositing film 205 with thickness 225 substantially equal to one quarter of the wavelength of incident radiation 215 permits a destructive interference condition to exist between radiation reflected at the interface between film 205 and substrate 210 and radiation reflected at the interface between film 205 and the external medium, such as air, vacuum, inert gas, aqueous media, or the like. For incident radiation 215 in the infrared range, thickness 225 can be determined such that the path length of incident radiation 215 through film 205 is from about 200 nm to about 400 nm (e.g., about 255 nm for a diode laser at 1020 nm), corresponding to incident wavelengths from 800 nm to about 1600 nm. For normal incidence, where incident radiation 215 is expected to include a range of wavelengths/energies, thickness 225 can correspond to a quarter wavelength of a specific energy. Sources of incident radiation 215 can include but are not limited to black body radiation (e.g., solar radiation), coherent sources (e.g., lasers), and/or ambient sources (e.g., glow discharge sources, arc discharge sources, LED sources, incandescent sources, etc.). In an illustrative example, for an antireflective coating on an optical element in an infrared fiber optic transmission line using a wavelength of 850 nm, 1300 nm or 1310 nm, or 1550 nm, thickness 225 for a normally incident beam can be about 213 nm, about 325 nm, and about 383 nm, respectively. As the destructive interference condition can be sensitive to thickness 225, with a 10 nm difference in thickness 225 resulting in a 40 nm shift in the interference wavelength, in this context, “about” refers to allowable fabrication tolerances of the fabrication methods used to prepare example antireflective structure 200, such that a tolerable deviation from the stated value is understood to not inhibit quarter-wave interference.

In some embodiments, thickness 225 corresponds to a balance between structural interactions between nanostructured gel 135 that reduce scattered radiation 220 and absorbance characteristics of film 205 that are generally understood to be path-length dependent (e.g., increasing with thickness 225). It is understood that the inclusion of primary pores 170 and secondary pores 175 in nanostructured gel 135, being nanostructured features smaller than the length scale of the wavelength of UV-Visible-IR photons, can interact with incident radiation 215 and reduce scattering at the interface between film 205 and substrate 210.

As such, in some embodiments, thickness 225 is from about 200 nm to about 1000 nm, including fractions and interpolations thereof. For example, thickness 225 can be about 200 nm, about 210 nm, about 220 nm, about 230 nm, about 240 nm, about 250 nm, about 260 nm, about 270 nm, about 280 nm, about 290 nm, about 300 nm, about 410 nm, about 420 nm, about 430 nm, about 440 nm, about 450 nm, about 460 nm, about 470 nm, about 480 nm, about 490 nm, about 500 nm, about 510 nm, about 520 nm, about 530 nm, about 540 nm, about 550 nm, about 560 nm, about 570 nm, about 580 nm, about 590 nm, about 600 nm, about 610 nm, about 620 nm, about 630 nm, about 640 nm, about 650 nm, about 660 nm, about 670 nm, about 680 nm, about 690 nm, about 700 nm, about 710 nm, about 720 nm, about 730 nm, about 740 nm, about 750 nm, about 760 nm, about 770 nm, about 780 nm, about 790 nm, about 800 nm, about 810 nm, about 820 nm, about 830 nm, about 840 nm, about 850 nm, about 860 nm, about 870 nm, about 880 nm, about 890 nm, about 900 nm, about 910 nm, about 920 nm, about 930 nm, about 940 nm, about 950 nm, about 960 nm, about 970 nm, about 980 nm, about 990 nm, or about 1000 nm.

In contrast to conventional approaches that form bilayer or multilayer porous films with separate layers of large pores and small pores, or complex patterned deposition/etch processes that produce highly organized arrays of nanopyramids, nanorods, or nanocones (requiring clean-room facilities and highly complex equipment), nanostructured gel 135 includes primary pores and secondary pores distributed throughout the volume of nanostructured gel 135. Advantageously, the distribution of pores throughout the volume of nanostructured gel 135 improves transmission of incident radiation 215 through substrate 210 from a wider range of incidence angles relative to an anti-reflective coating that depends entirely on path-length (e.g., effective film thickness) to create a destructive interference condition.

Film 205 can include an encapsulation material 235 disposed overlying nanostructured gel 135. Encapsulation material 235 can include but are not limited to materials that act as barriers to oxygen and/or water diffusion, thereby improving the structural and/or chemical stability of nanostructured film 135. Encapsulation material 235 can be or include a polymeric or glass material selected to permit transmission of incident radiation 215. For example, where incident radiation 215 is in the infrared range, encapsulation material 235 can be substantially transparent or translucent to infrared radiation. In this context, “substantially transparent” refers to a material that absorbs negligible or no incident radiation 215 over a relevant energy range for upconversion. For example, substantially transparent or translucent can refer to a material that is greater than or equal to about 70% transmissive in the relevant energy range. In some embodiments, encapsulation material 235 can be disposed as an encapsulation layer overlying nanostructured gel 135. In some embodiments, encapsulation material 235 can be blended with a dispersion of nanostructured gel 135 in a medium used for spin-coating, such that nanostructured gel 135 particles 165 and/or particle aggregates are encapsulated throughout film 205.

As part of functioning to attenuate scattered radiation 220, film 205 can be characterized by an index of refraction (n_{f}) that is smaller than an index of refraction of substrate 210 (nₛ). Similarly, encapsulation material 235 can be characterized by an index of refraction (nₑ) that is smaller than both n_{f} and nₛ. In an illustrative example, where substrate is formed of glass, nₛ is about 1.8, n_{f} is about 1.6, and nₑ is about 1.4. The nanostructure of NaYF gels of the current disclosure implicates a nonlinear index of refraction that can be dependent at least in part on size of particles 165, particle aggregates, doping extent, or the like.

In some embodiments, nanostructured gel 135 includes a lanthanide dopant 230. Lanthanide dopant 230 can include but is not limited to Yb (ytterbium), Er (erbium), or other lanthanides that facilitate up-conversion of incident radiation 215, emitting radiation (e.g., upconverted photons) at a higher energy than the energy of incident radiation 215 (e.g., incident photons). Advantageously, lanthanide dopant 230 can induce up-conversion photoluminescence 235 from nanostructured gel 135 including emission of photons having energies that are not integer multiples of incident radiation 215 (e.g., the mechanism of two-photon upconversion). In this way, up-conversion photoluminescence can absorb heat from film 205 and/or substrate 210 as part of generating upconverted photons, thereby reducing the temperature of example antireflective structure 200 in a process termed “optical cooling.” In some embodiments, NaYF materials can be doped with lanthanide dopant 230 at a concentration from about 1% to about 50%, including fractions and interpolations thereof. For example, upconversion can be elicited from doped materials containing 2% Er and 10%-30% ytterbium. In some embodiments, doped nanostructured gel materials include about 5%, about 10%, about 15%, about 20%, about 25%, about 30%, about 35%, about 40%, about 45%, or about 50%. In some cases dopant concentration is governed by saturation limits, but can also be governed by optical limits, such that upconversion properties exhibit a nonlinear optimium concentration, beyond which upconversion optical properties of doped materials do not improve with further doping.

In some embodiments, lanthanide dopant 230 is incorporated as ytterbium ions Yb³⁺, and incident radiation 215 is provided in the infrared range to cool nanostructured gel 135. In this way, incident radiation 215 can include radiation from sources configured to cool film 205 and/or substrate 210, as well as radiation from other sources for which transmission through substrate 210 is improved. In an illustrative example, an optical element (e.g., a filter, lens, or the like) provided with film 205 can be irradiated by incident radiation 215 from a signal carrying beam, such as laser communication system, and by a separate cooling beam at a wavelength configured to be absorbed and upconverted to cool film 205 and/or substrate 210. The signal carrying beam can be transmitted through substrate 210 with reduced scattering, while the cooling beam can be absorbed by film 205 to absorb heat. In the example of Yb³⁺, incident radiation 215 can be in the infrared range, such as at 1020 nm generated by a diode laser. Advantageously, excluding organic solvents, capping ligands, or counterions improves the performance of nanostructured gel 135 as an up-conversion material, based at least in part on the characteristic broad absorption of infrared radiation by organic chemicals and polymers.

Further description of nanostructured NaYF gels and their application in optical coatings and energy storage are provided in the following Examples. The compositions, methods, systems, and configurations described are non-limiting and do not represent a preferred embodiment.

### Example 1: Multi-Step Crystallization and Chemical Evolution of Sodium Yttrium Fluoride

Classical nucleation theory (CNT), first described by Gibbs over 140 years ago, has been a robust model for describing the formation of crystals from a homogeneous solution. Despite its simplicity and general validity for many crystallization processes, there exist some processes that proceed via so-called “nonclassical” mechanisms. Examples of nonclassical mechanisms include the formation of amorphous or poorly-crystalline species and the oriented aggregation and attachment of individual building blocks. Nonclassical crystallization can be understood to be a realization of Ostwald's step rule, which suggests that systems tend to approach a thermodynamically stable phase through a series of intermediate states that are closer in free energy to the initial state.

Two-step nucleation of iron containing crystals via a dense liquid phase (DLP) describes one form of nonclassical crystallization that proceeds via spinodal decomposition (SD). In the SD mechanism, a supersaturated initial phase spontaneously separates into an iron-poor phase and an ion-rich phase, from which crystals nucleate, possibly via an amorphous intermediate. This mechanism has been observed directly via liquid cell transmission electron microscopy (TEM) of gold nucleation from solution as well as in electrochemical reactions in nanoparticles, in molecular dynamics (MD) and kinetic studies of calcium carbonate, in bulk chemical studies of MgSO₄ at high temperature, by optical microscopy in crystallizable polymer solutions, in MD simulations of highly supersaturated NaCl solutions, and in optical microscopy and light scattering studies of protein solutions. Some systems have also shown a distinct intermediate step in which the DLP condenses into an amorphous phase prior to crystallization.

The stoichiometry of the intermediate phases remains unexplained, at least in part because intermediate states are transient, ill-defined (e.g., spatially), and are typically replaced during generation of a final stable phase. In some cases, compositions of ion-rich and ion-poor liquids are defined by a phase line that traverses a range of compositions rather than by a set of line compounds. In this context, the term “line compounds” refers to compositions/stoichiometries that fully interconvert as the conditions change. In contrast stoichiometries/compositions of the present disclosure can vary smoothly as conditions change, for example, by medium exchange, temperature change, or the like. Therefore, during crystallization, ions are rejected from or drawn into the solidifying regions of the ion-rich liquid droplets. Unlike previously investigated nonclassical systems, in which intermediate phases are line compounds, which can be identical for each phase, for example, as in the case of CaCO3 (ignoring waters of hydration), or can be distinct and require chemical transformation, as for the calcium phosphate system.

For calcium phosphate crystallization, charged calcium triphosphate species undergo aggregation accompanied by Ca²⁺ binding and deprotonation to create the amorphous phase, and then undergo a second step of Ca²⁺ binding and deprotonation to create a first crystalline phase. In a DLP-mediated pathway, on the other hand, ions may exchange more dynamically rather than via specific transformations to these discrete line compounds. The added complexity in these two-step pathways is further emphasized when the final compound has a ternary or more complex stoichiometry. Given the common occurrence of the formation of DLPs in supersaturated solutions and the preponderance of ternary and more complex compounds in natural and synthetic systems, there remains a paucity of critical study of the chemical evolution of intermediate phases in ternary, quaternary, or higher order systems.

Embodiments of the present disclosure include a multi-step crystal growth pathway using a model system based on ternary sodium-yttrium-fluoride (NaYF) materials. NaYF represents an advantageous system for exploring the role of chemical evolution during crystallization, based at least in part on the variable stoichiometry of NaYF materials as a combination of NaF and YF₃ during crystallization. As described in more detail, below, stoichiometry of NaYF materials can vary continuously over a range of values described by the structure: Na_{0.5-x}Y_{0.5+x}F₂₊₂ₓ, or (0.5−x)NaF·(0.5+x)YF3, where 0<x<0.5. When x=0, the structure represents NaYF₄, which can refer to a material described as NaYF for which the stoichiometry is complete (e.g., an end state of a crystallization process to produce sodium-yttrium-fluoride). NaYF is used when describing embodiments of the present disclosure when referring to this material to reflect the variable stoichiometry of materials described herein.

Typical aqueous syntheses of NaYF use either microemulsion solvent systems or organic capping ligands for the purpose of controlling both the size and shape of discrete nanocrystals. In contrast, in some embodiments of the present disclosure, ligand-free NaYF materials are described, synthesized without organic solvents, capping ligands, or counterions, to provide a clear understanding of the role of solvated aqueous ion dynamics by eliminating ion chelation and surface passivation by organic species. Advantageously, such techniques also improve suitability of NaYF materials for application in energy storage devices, optical elements, and optical cooling films, as described in more detail in reference to FIGS. 1-2.

Results presented herein demonstrate the formation of a DLP in the NaYF system through a two-step mechanism, followed by a third step of solid-state diffusion, described by a transient stoichiometry that determines a final stoichiometry of a polycrystalline nanostructured material. Such transient stoichiometry has not previously been studied in systems that proceed by SD. Further investigation of this mechanism could also lead to the development of many functional materials.

### Results and Discussion

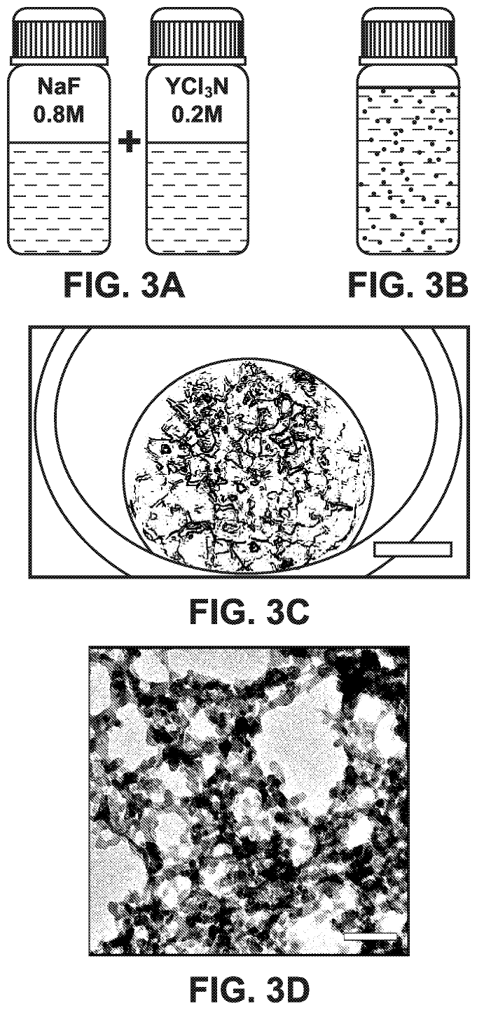

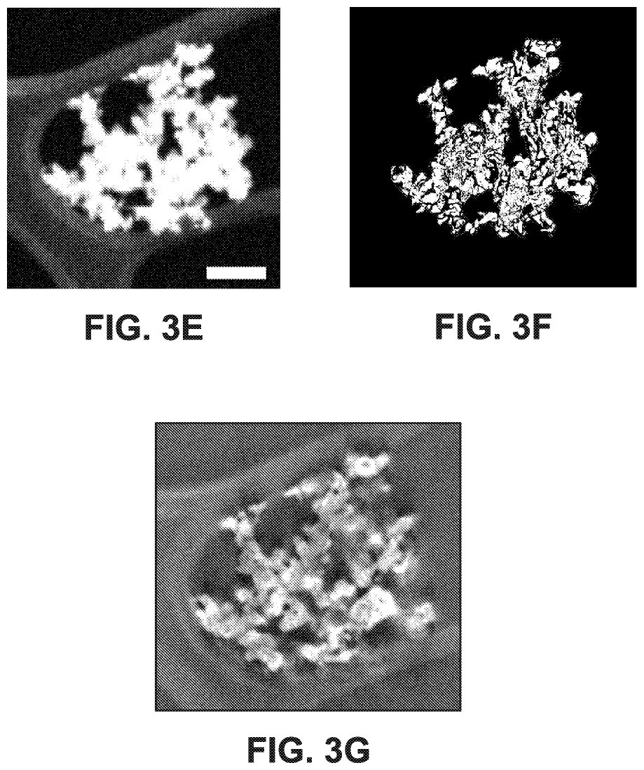

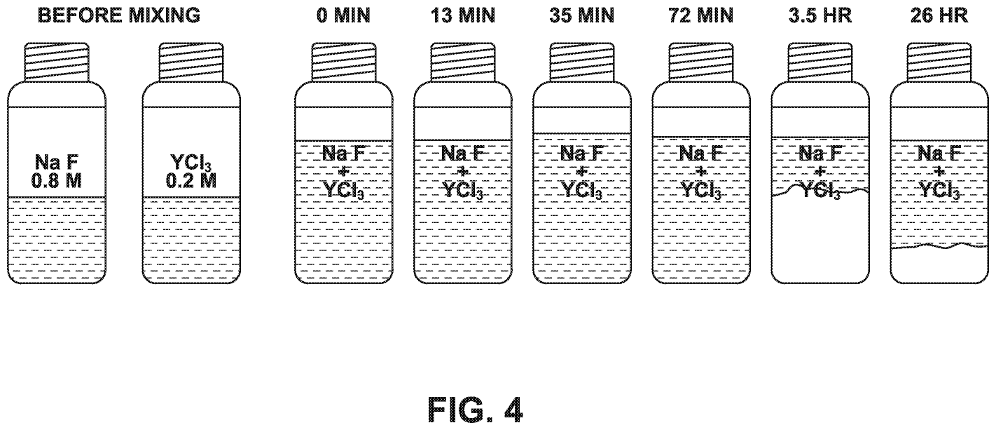

Nucleation and growth of NaYF materials in the absence of organic ligands was investigated through aqueous electrolyte solutions of both NaF and YF₃, combined at standard conditions with relative concentrations stoichiometric to NaYF₄ (FIG. 3A). A gel-like material (FIG. 3B) was observed to form spontaneously upon blending the NaF and YF₃ solutions. The gel-like material was filtered to a translucent solid (FIG. 3C). The gel remains stable for several hours, after which it begins to collapse into a whitish powder (FIG. 4).

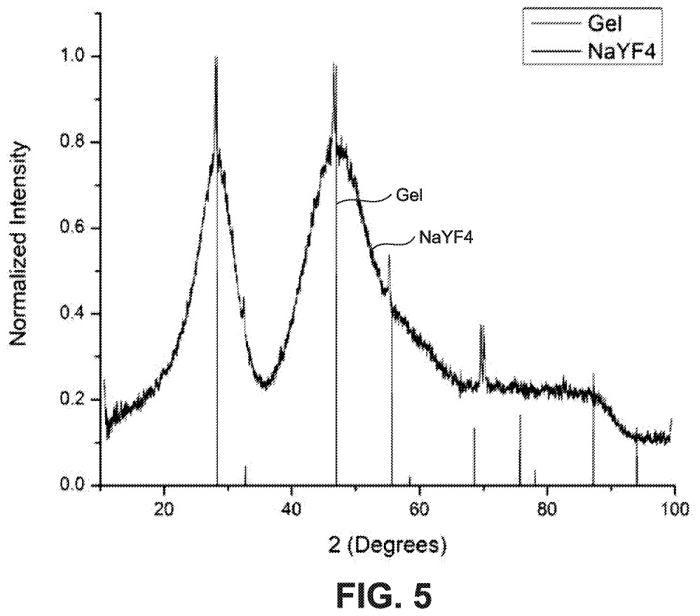

TEM imaging of the gel shows an interconnected, porous structure (FIG. 3D). Scanning TEM (STEM) tomography reveals not only the interconnected three-dimensional morphology (FIG. 3F) but also the open-cell structure that can't be seen in conventional STEM (FIG. 3G). Brunauer-Emmett-Teller (BET) surface area measurements reveal a surface area of the gel phase on the order of 10-1000 m²/g (e.g., 50-150 m²/g), and powder X-ray diffraction (XRD) data reveal peaks consistent with α-NaYF or a similar cubic material (FIG. 5).

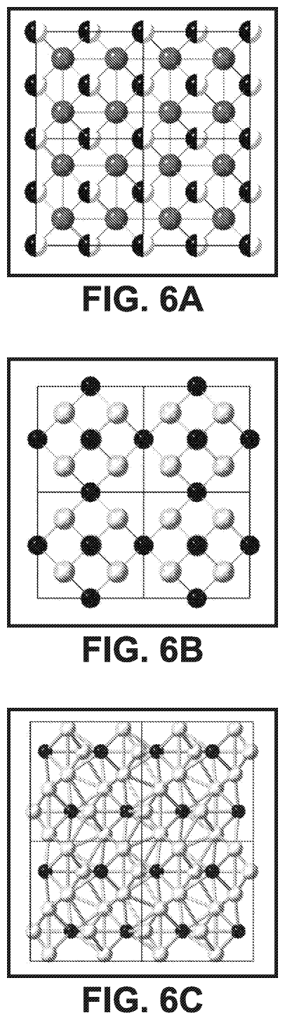

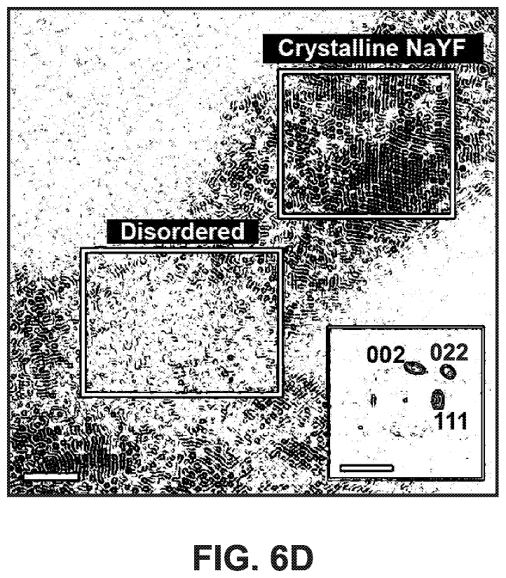

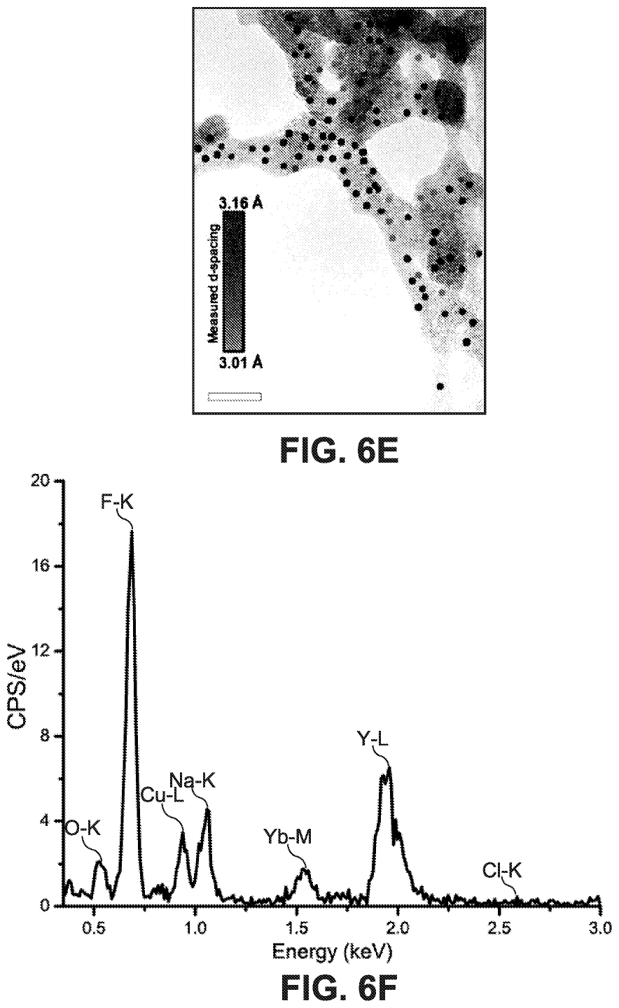

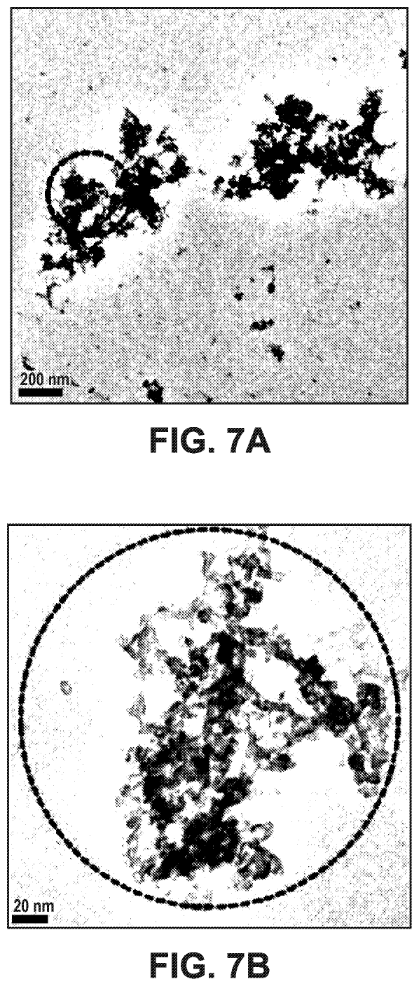

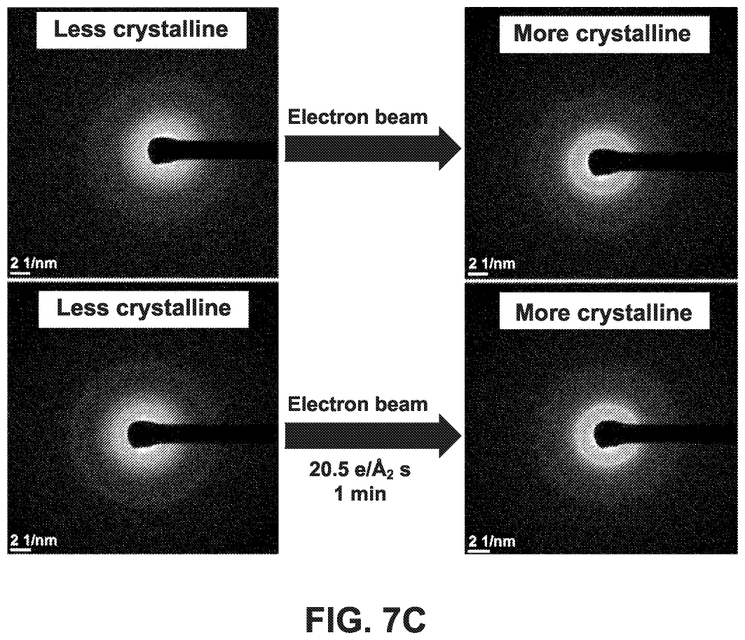

XRD data were consistent with nanocrystalline α-NaYF (FIG. 5). XRD data was not conclusive that the gel is purely α-NaYF. To further complicate the analysis of these data, TEM data suggest that there are some amorphous, poorly crystalline, or otherwise disordered regions (FIG. 6D). *NOTE: TEM image in FIG. 6D has been filtered to satisfy figure publication requirements, but order information is preserved. Furthermore, experimental microscopy using TEM revealed beam-induced crystallization (FIGS. 7A-C), which suggests that high resolution TEM (HRTEM) measurements are underestimating the distribution of amorphous and poorly crystalline materials. Under the assumption that any crystals that are induced by the beam in vacuum will have the same composition as their disordered precursor, beam-induced crystallization to estimate the local composition of the material.

Using custom fast Fourier transform (FFT) indexing software (FIG. 6E), it was found that most regions of the gel contain an FFT peak between 3.00 and 3.16 Å The FFT peak was indexed to the (111) plane of a cubic NaF—YF₃ structure, with smaller d-spacings corresponding to a more NaF-rich structure (more similar to NaYF₄, FIG. 6A), and larger d-spacings corresponding to a more NaF-poor structure (more similar to cubic YF₃, FIG. 6B). This analysis shows relatively smooth fluctuations between compositional states, showing that the NaF:YF₃ ratio is not constant in the recovered gel and that it should be thought of as in a composition between YF₃ and NaYF₄. The measured d-spacings are shifted from literature values for the (111) planes of cubic NaYF₄ and YF₃ due to approximations in measuring the scale bar, but the individual spots are accurate relative to each other, and therefore the trend is not affected.

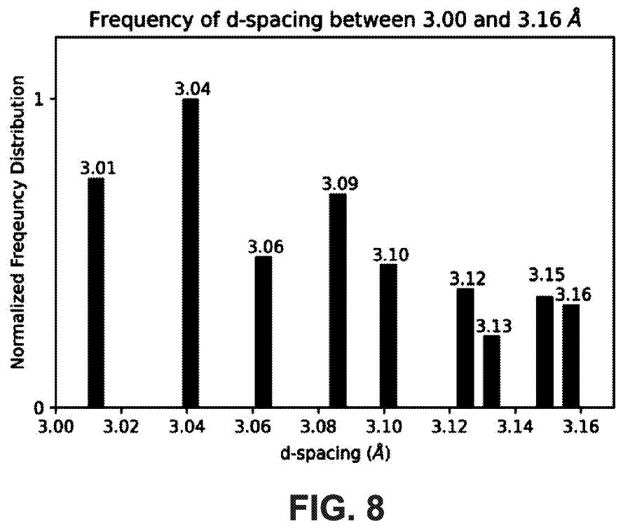

A histogram of the detected d-spacings can be found in FIG. 8. It should be noted that the thermodynamically stable orthorhombic structure of YF₃ (FIG. 6C) was not observed in the gel. Considering the crystal structures of these two phases, it is notable that they share a nearly identical lattice of fluoride ions (though each unit cell of the YF₃ contains an extra fluoride ion at the center), but that the corners of the YF₃ unit cell are unoccupied, which results in channels defined through the crystal structure.

Without being bound to a particular physical phenomenon or mechanistic explanation, it is contemplated that the channels defined in cubic phase NaYF materials, which are absent in orthorhombic or hegaxonal materials, facilitate improved diffusion of ions into the lattice, allowing for local variations in stoichiometry. This is consistent with much of the literature regarding cubic NaF—YF₃ structures grown from melt insofar as that the bulk material can be thought of as a solid solution of NaF and YF₃.

The gel can initially form both amorphous and cubic domains of YF₃ while the excess NaF in solution slowly incorporates into the matrix to form a more stable cubic NaYF phase. Distinct XRD peaks for YF₃ and NaYF₄ were not observed in recovered gel materials based at least in part on the effects of nonstoichiometric structures and Scherrer broadening. To investigate the gradual transition from YF₃ to NaYF, a cation substitution experiment was conducted on the gel using monovalent potassium cations. By removing the gel from its native solution, it is possible to temporarily suspend the process of monovalent sodium ion incorporation.

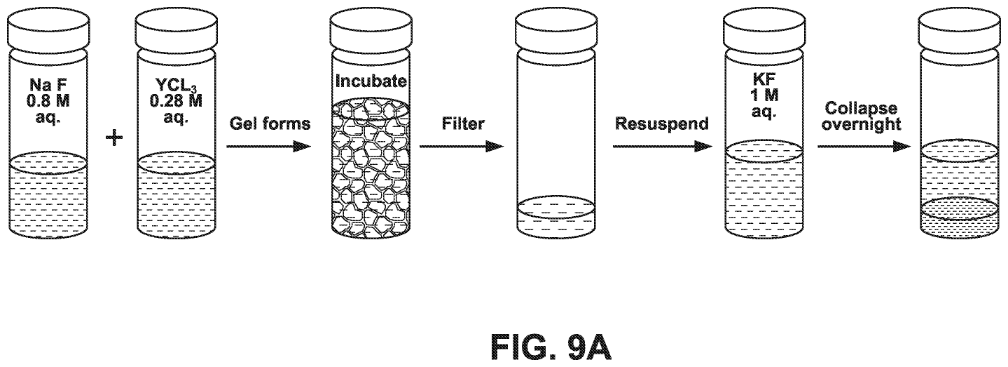

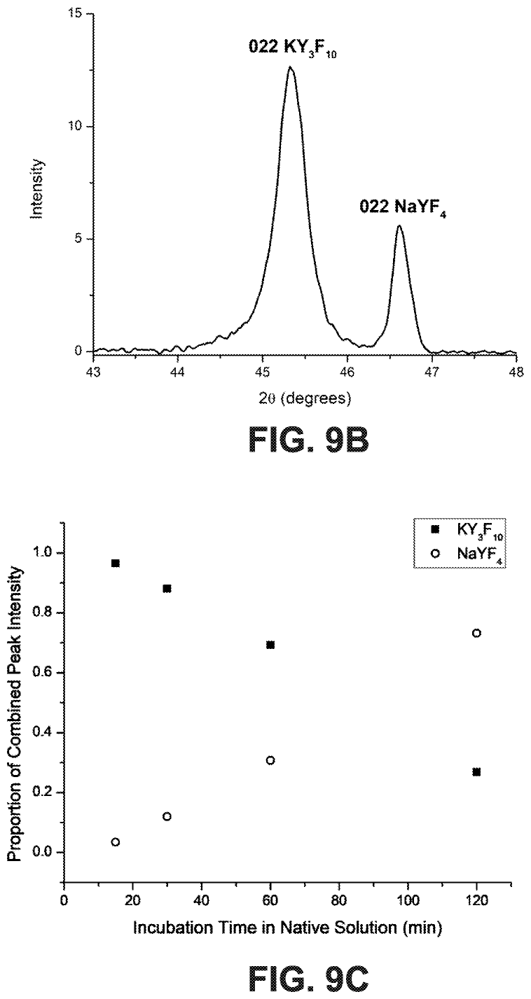

After submerging the recovered NaYF gel in a concentrated (1M) KF solution, it was observed that the remaining sodium-poor regions incorporate KF to form KY₃F₁₀ (KYF) (FIG. 9A), which is distinguishable in XRD after the gel is allowed to fully collapse into single crystals (FIG. 9B). While KYF can form in multiple stoichiometries, the KY₃F₁₀ stoichiometry forms in this case based at least in part on its stable in the cubic crystal phase and having the lowest K⁺:Y³⁺ ion ratio. By varying the amount of time spent incubating in the native solution before filtering and transferring to the KF solution (t_{inc}), the quantity of sodium incorporated into the gel can be observed for the incubation time relative to remaining YF₃, which can be observed after converting to KYF. As t_{inc} increases from about 15 minutes to about 120 minutes, the proportion of the sodium phase was observed to increase linearly with a corresponding linear decrease in the relative amount of material that incorporates potassium (FIG. 9C). As such, the incorporation of sodium into the crystal structure occurs as the result of solid-state diffusion into the gel and is thus unambiguously a separate step from the initial formation of the yttrium-rich gel phase.

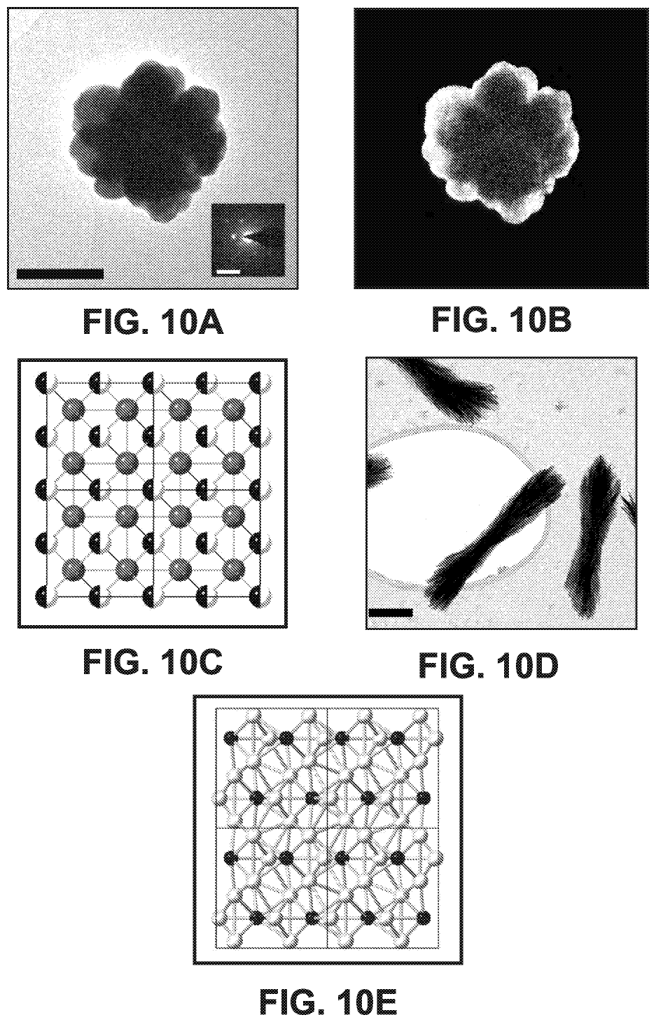

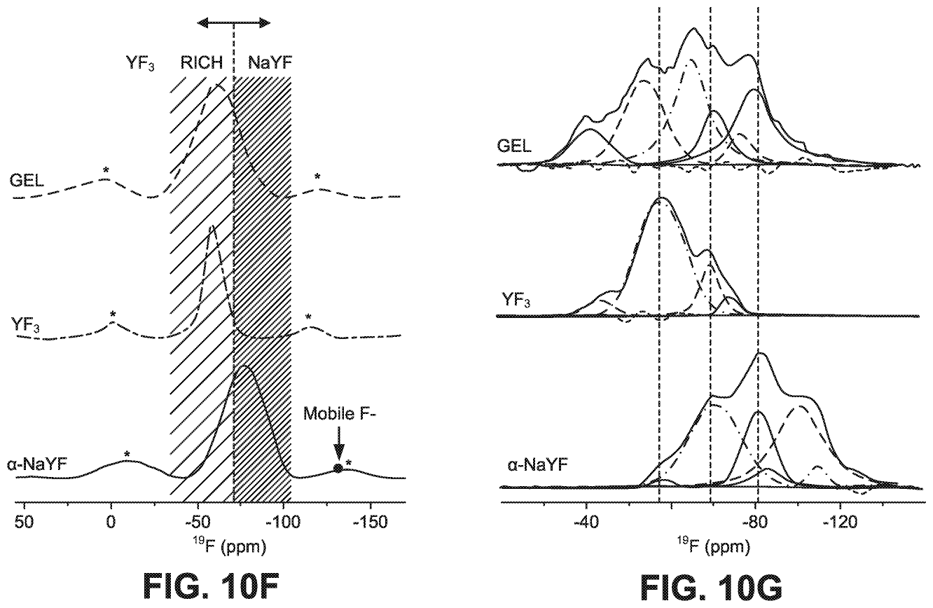

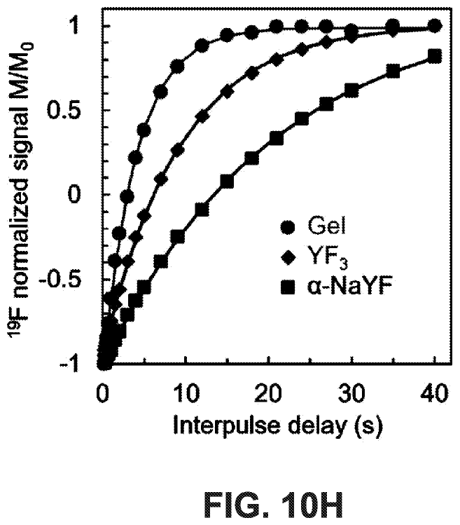

To further understand the nature of the gel, solid-state nuclear magnetic resonance spectroscopy (SSNMR) was completed to characterize the gel product compared to crystallized a-NaYF product (FIG. 10A) as well as orthorhombic YF₃ (FIG. 10B). Orthorhombic YF₃ was used rather than the previously discussed cubic phase because the cubic phase is a metastable product that seems to only form in reactions similar to those reported here. As previously described, conventional techniques include incorporation of a countercation from the fluoride precursor that obscures NMR spectra. As shown in ¹⁹F spin-echo magic angle spinning (MAS) NMR (FIG. 10C) the gel exhibits a broad resonance centered at −61 ppm with a peak width of 30 ppm. The ¹⁹F chemical shift is highly sensitive to its coordination environment in molten fluoride mixtures, displaying a nonlinear and monotonous increase from −225 ppm to −28 ppm by increasing the concentration of YF₃ from 0 to 100% in the NaF—YF₃ mixture.

Compared to orthorhombic YF₃, which shows a relatively sharper peak at −58 ppm with a width of 12 ppm, and a-NaYF, which has a similarly broad resonance at −77 ppm with a width of 28 ppm, these data are again consistent with a gel that consists of some regions that are more similar to YF₃ and others that are closer to NaYF₄. Because the broadness of the NaYF ¹⁹F spectrum can be attributed to a large distribution of isotropic chemical shifts due to the random arrangement of Na⁺ and Y³⁺ around F⁻, T₂-filtered ¹⁹F spectra are presented in FIG. 10D, which reduce signals from faster-relaxing components and thereby allow for finer resolution of the remaining signal.

The respective deconvolution of the resonances reveal that the gel includes components similar to those in a-NaYF and YF₃ (−81 ppm and −69 ppm, respectively), however the main peaks in the region corresponding to YF₃ are not consistent with the major peak of orthorhombic YF₃ at 58 ppm, due to the variation in the coordination geometries of bridging fluoride ions between the cubic and orthorhombic polymorphs of YF₃ as well as amorphous regions. This emphasizes that the YF₃ product in the gel is not the orthorhombic phase but rather cubic and amorphous YF₃. Furthermore, FIG. 10E shows that the ¹⁹F spin-lattice relaxation time constant T₁ drops significantly from 19 s for a-NaYF and 9.2 s for orthorhombic YF₃ to 3.2 s for the gel, which indicates that the major fluoride species are more mobile and less ordered in the gel phase. This is consistent with the observation that there are significant amorphous, poorly crystalline, and disordered regions in the gel and also emphasizes the propensity for this material to undergo solid-state diffusion.

Single-pulse ²³Na NMR spectra of the gel and the α-NaYF samples, respectively, both contain major resonances centered at −18 ppm and −9.5 ppm, which were assigned respectively to Na⁺ sites in the bulk nanoparticles, and to Na⁺ sites at the surface or near defects. The fraction of the −9.5 ppm peak changes from 35% in α-NaYF to 75% in the gel sample, suggesting that the gel has over twice as many surface or defective Na⁺ sites as compared to the final crystalline product.

Thus far, clear evidence is provided for crystallization following the formation of an amorphous phase as well as of the solid-state diffusion of ions following the initial separation. This is consistent with the many well-characterized two-step crystallization mechanisms in which the initial separation occurs via a DLP, likely formed by SD.

To model preliminary ion segregation and computationally predict time-scales affiliated with SD, a modified model was developed that solves the multicomponent Cahn-Morral equation for a simplified version of the NaYF system. The Cahn-Morral equation is a multicomponent analogue to the Cahn-Hilliard equation that describes the dynamics of phase separation and coarsening in a binary mixture. SD phase separation is characterized by clustering of species so that diffusion occurs “up” concentration gradients, rendering the classical diffusive transport models ill-posed. Spinodal phase separation is limited by a thermodynamically modified diffusion process that includes contributions from compositional gradients in the free energy of the system and in the chemical potential of each species.

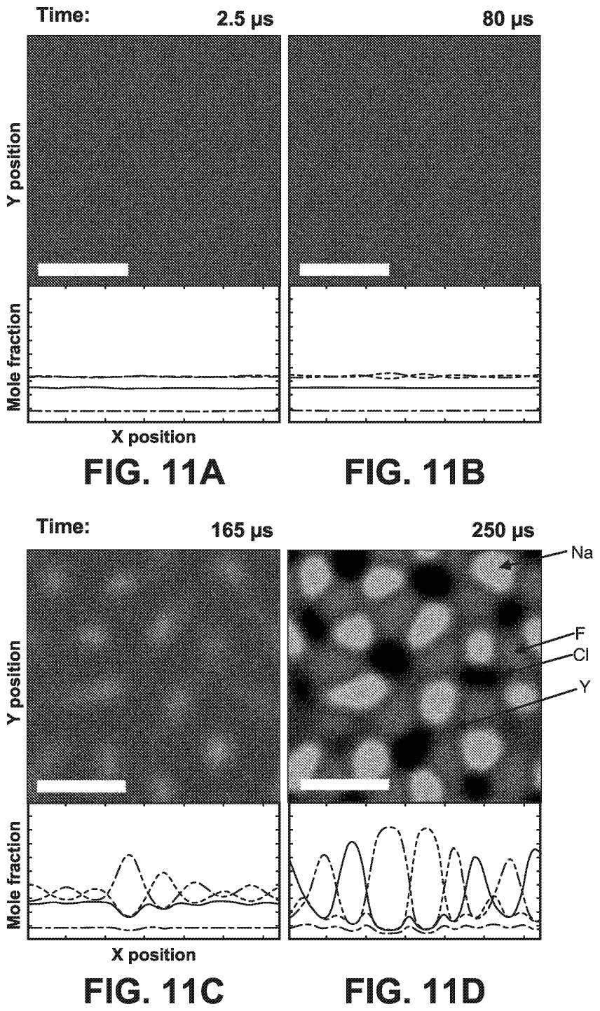

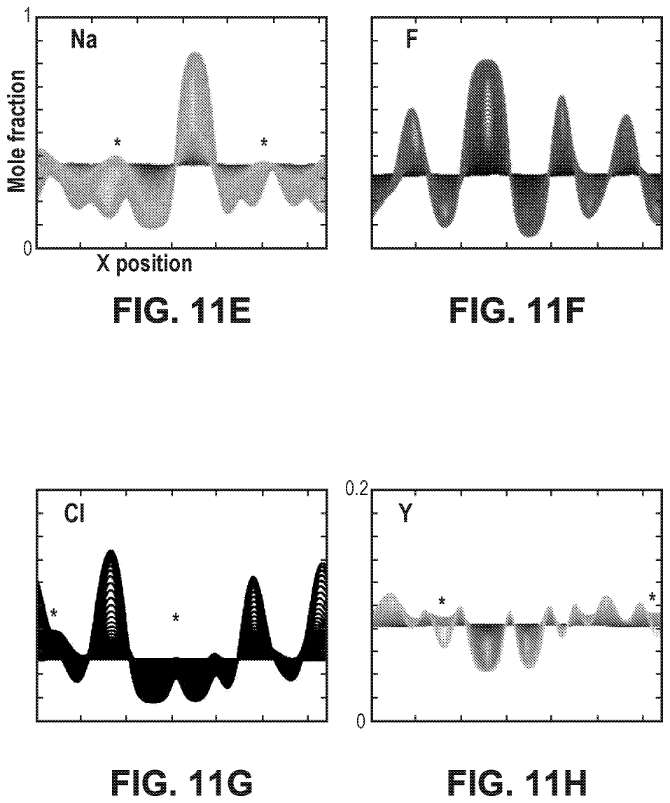

Including contributions from compositional gradients in the free energy of the system and in the chemical potential of each species provides a well-posed model of diffusion allowing for diffusion up gradients in composition characteristic of SD while also bounding the magnitude of composition buildup. The main parameters that affect the dynamics of the phase separation are the modified chemical potentials of the individual components, including thermodynamic parameters characterizing the homogeneous free energy density and the phenomenological gradient energy coefficients, and the diffusion coefficients of each species in the system. As a first-order approximation, individual ions in the reaction 4NaF+YCl₃→NaY F₄+3NaCl were modeled as individual components in the same proportions as in the stoichiometric reaction, all with a diffusion coefficient of 1.4×10⁻⁵ cm²s⁻¹, which is an average of the actual aqueous diffusion coefficients of each ion. While this model clearly represents only a first-order approximation of the system, it does allow approximation that the system takes about 250 μs to reach a relatively steady state at standard conditions (FIG. 11A). Furthermore, by considering the time-resolved model from 0-250 μs (FIG. 11B), it becomes apparent that regions of high or low concentration of various components can form and disappear prior to reaching a steady state, as marked by asterisks (*) in the plots.

There are some shortcomings to this modelling approach, the most obvious being that it does not include electrostatic interactions between ions. Furthermore, the separation of the phases from solution cannot be fully separated from simultaneous nucleation and solid-state diffusion phenomena. This intricacy illustrates an intriguing aspect of the ternary NaYF system, namely, that its formation cannot be viewed purely as a two-step nucleation and growth mechanism. Rather, the gradual solid-state diffusion can be thought of as a fundamental part of the overall growth pathway.

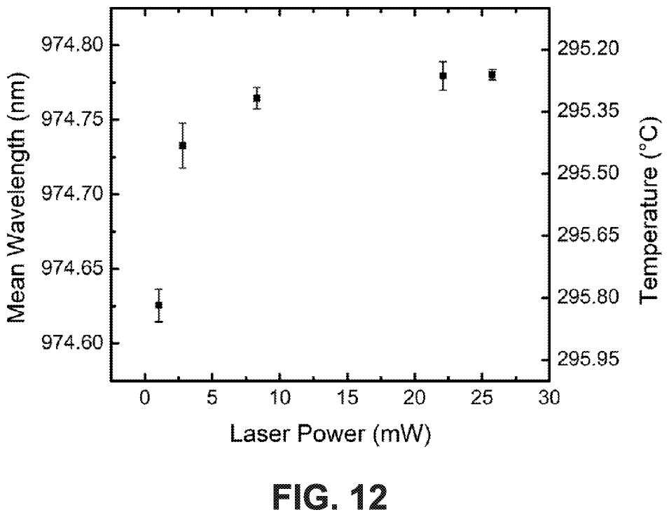

The multi-step crystal growth mechanism opens the door for further applications of NaYF and similar materials that take advantage of high surface area, cubic crystal structure, and open-cell porous structure. For example, NaYF-gel materials can be incorporated into energy storage applications, as well as for antireflective coatings. Anti-reflective coatings are an interesting application based at least in part on the possibility of employing the optical refrigeration properties of NaYF to actively cool the surface. For example, in preliminary experiments optical refrigeration of the NaYF gel was observed when doped with 10% ytterbium. Measurements indicate that a doped NaYF gel can be laser cooled by approximately 0.55° C. and does not heat under laser irradiation (FIG. 12), indicating that it can be incorporated into actively cooled anti-reflective coatings. Advantageously, the lack of organic ligands on the surface prevent a reduction of cooling efficiency due at least in part to optical heating of organic species on the surface.

### Conclusions

Crystal nucleation and growth are often described based on the simple addition of monomer units from solution. These depictions of the process typically do not take into account the fact that both the monomer units and the formed solid undergo compositional and structural changes during crystallization. It is shown that upon the mixture of NaF and YCl₃ in water, a gel separates from solution which then undergoes crystallization. This system also includes an additional step of solid-state diffusion, where the product initially resembles cubic YF₃ but then undergoes a gradual change of chemical stoichiometry to form NaYF over the course of several hours.

### Example 2—Synthesis and Characterization of Nanostructured N_{A}YF Gels

Synthesis: Nanostructured NaYF gel is synthesized by mixing a 0.2 M YCl₃ solution with a 0.8 M NaF solution in nanopure water. The mixture is then inverted to fully combine. The gel is then poured into a Buchner funnel with filter paper over vacuum either immediately after mixing or” after waiting a specified amount of time and allowed to dry.

Ion Replacement in Gel: The gel was synthesized as described above and allowed to incubate in its original solution for an incubation period from about 10 minutes to about 200 minutes, including fractions and interpolations thereof, as described in reference to FIG. 9C. After the incubation time has passed, the sample is filtered as described above and rinsed with nanopure water, and the product is resuspended in a solution of 1M KF. The mixture was vortexed until it appeared uniform and was allowed to settle overnight. After fully settling, the product was centrifuged and washed with water and ethanol respectively and oven-dried.

Powder X-Ray Diffraction Powder X-Ray Diffraction (XRD) samples were prepared by drop-casting a concentrated slurry of the sample onto [100] silicon wafers. XRD spectra were taken on a Bruker D8 Discover Microfocus diffractometer with a Dectris Pilatus3 R 100K-A 2D detector and a Cu Kα X-ray source with a 0.5 mm collimator. A Coupled 2θ/θ scan was performed from 16° to 93° with a 5.5° increment to create overlap, with a scan time of 30 seconds per θ. During the scans, the sample was oscillated in the x, y, and φ directions to remove the effects of texture and improve statistics. An air scatter screen was used to reduce background. Scans were integrated, indexed, processed, and analyzed using Bruker Diffrac. Eva software.

TEM TEM images were taken on FEI G2 TECNAI F20 S/TEM instruments at 200 kV with either a Gatan Ultrascan CCD or an FEI Eagle CCD camera. Images were processed using Gatan Digital Micrograph (DM) and Tecnai Imaging and Analysis (TIA) software. STEM Tomographic reconstructions were compiled using FEI Inspect3D software, using a simultaneous iterative re-construction technique (SIRT) with 50 iterations. These reconstructions were then visualized using IMOD. Scanning transmission electron microscopy (STEM) bright field (BF) imaging and STEM-energy dispersive x-ray spectroscopy (EDS) were performed in a Nion UltraSTEM-X operated at 60 kV. The microscope was equipped with a Bruker XFlash windowless silicon drift detector, and EDS data were analyzed using Bruker Esprit software. The NaYF samples were dispersed in ethanol and dropcast onto Cu TEM grids with lacey carbon films.

Computational methods The TEM spatial FFT analysis was performed using a purpose-built algorithm encoded in Python. To determine the scale, the code optically detected the scale bar printed on the image by the TEM software (Tecnai Imaging and Analysis) and a calibration factor of 22.800 pixels/nm was obtained. Points on the image were manually selected, and a region of 100 px×100 px centered on that point was isolated. From this point the script was set up to perform automated calculations. 2D-FFT was performed for each region, followed by a Gaussian background subtraction to enhance the peaks in the reciprocal space. Several filters and masks were applied on the intensity to obtain the peak locations, which was used to determine d-spacing in the inverse space. All detected peaks were organized into a histogram based on measured d-spacing, and the region corresponding to the 111 peak for both α-NaYF and cubic YF₃ was isolated (3.00-3.16 A°), with all other measured peaks discarded. A weighted average was performed on the remaining peaks with their peak intensity as respective weights. This resulted in a single d-spacing value associated with each region. This value was then mapped onto a gradient and displayed as a circle at the center of each region on the TEM image.

NMR ¹⁹F and ²³Na magic angle spinning (MAS) NMR spectra were collected on a Bruker Avance III spectrometer with a field strength of 600 MHz (14.1 T, corresponding to 564.71 MHz for ¹⁹F and 158.75 MHz for 23Na) using 2.5 mm Bruker rotors at a spinning speed of 32 kHz. The regular 90° pulse width was 3.1 μs for ¹⁹F and 2.9 μs for ²³Na. ¹⁹F spin-lattice relaxation times (T1) were measured using the inversion-recovery method (180°−τdelay−90°−acquisition), and spin-spin relaxation times (T2) using the Carr-Purcell-Meiboom-Gill (CPMG) method (90°−τ_{delay}−[180°−τ_{delay}]n−acquisition) after 2-96 π-pulses with an interpulse delay time τ_{delay}=62.5 μs, which was synchronized to the spinning speed of 32 kHz. The spin-echo ¹⁹F spectra were acquired after two rotor cycles with an interpulse delay of 31.25 μs. Single-pulse ²³Na spectra were acquired with a hard RF pulse with a π/20 flip angle of 0.58 μs, while soft RF pulses (90° pulse width at 15 μs) was used for preferentially exciting central transitions in the inverse-recovery experiments. Relaxation delays of 5×T1 (60-200 s for ¹⁹F and 1-2 s for ²³Na) were used in all experiments to ensure the full relaxation of all samples. The ¹⁹F chemical shift references were CF₃CH₂OH at −76.55 ppm and solid NaF at −224 ppm as a second reference. ²³Na chemical shifts were referenced to 1 M NaCl aqueous solution at 0 ppm.

### Example 3—Energy Storage Devices Incorporating Nanostructured NAYF-Gels

### Introduction

Energy storage devices built around lithium ion, sodium ion, fluoride ion, or other charge carriers are indispensable components of the modern technology ecosystem. Lithium-ion batteries, as coin cells, polymer pouch cells, or in other conformations, represent the principal technology for energy storage in mobile electronic devices including consumer electronics, electric vehicles, and other devices that rely on specific charge capacity with predictable and stable charge/discharge cycling.

A disadvantage of lithium-ion technologies arises from the relative scarcity of lithium and other rare earth and alkaline earth metals in mineral form. For example, based on data from 2020 produced by the US geological survey, only 23 countries have access to significant lithium resources, with an estimated 75% of world reserves located in Argentina, Bolivia, and Chile, of which only eight countries are currently producing lithium. Generally, lithium is extracted by mining or from brine concentration. Australia is the world's biggest supplier, with production of lithium ore generally by mining. Argentina, Chile and China, the next three largest producers, produce lithium by concentrating lithium salts in brine lakes.

Furthermore, lithium and other minerals are hazardous to humans and to the environment when concentrated. As such, lithium supply chains pose a risk of environmental contamination and adverse health effects to the people and locations involved. In particular, the location of lithium in remote regions, such as salt flats or mountain regions, implicates an increased environmental risk to otherwise relatively undamaged ecosystems.

For at least these reasons, a need exists for an alternative energy storage system that can operate with alternative charge carriers and/or with improved performance relative to existing Lithium ion-based energy storage devices. The work presented herein describes experiments carried out using a nanostructured gel including nonstoichiometric sodium yttrium fluoride (“NaYF”) materials incorporated into electrodes of coin-cell batteries. Advantageously, the experimental batteries described herein demonstrate the suitability of cubic-phase polycrystalline NaYF gels as a charge storage medium with application in lithium-ion batteries, sodium ion batteries, and halide (e.g., fluoride ion) batteries.

### Results and Discussion

Experimental coin cell batteries were prepared using nanostructured NaYF gels described in Examples 1-2, above, and as described in reference to FIG. 1. Two configurations were prepared, using (i) lithium ions and (ii) sodium ions as charge carriers. NaYF gels were pulverized and blended with carbon black and binder, then formed to fit the coin cell form factor and assembled. The ratio of components used was 64:21:15 of Gel:Carbon Black:Binder, by weight. Pulverization techniques for the NaYF gels included magnetic stirring and mortar and pestle, neither of which interfere with the microscopic porous structure of the gels or the crystal structure of the gels, described in Examples 1-2. The blended materials were pasted on copper foil using a doctor blade at a thickness of about 25 μm.

Electrolyte materials used for lithium cells (LiPF₄) included a mix of ethylene carbonate and diethylene carbonate at approximately 1:1 volume ratio, blended with fluoroethylene carbonate at about 10 wt % LiPF₄ in ethylene carbonate/diethylene carbonate. For sodium cells, sodium chlorate (NaClO₄) was used with electrolyte materials included propylene carbonate and fluoroethylene carbonate and about 10 wt % sodium chlorate. The separator material used a borosilicate glass microfiber filter. The coin cell material used was stainless steel.

At full charge, experimental cells were measured at a zero-current voltage of about 3.0 V+/−0.1 V, indicating that the gel material was suitable for use as a charge storage medium. Suitability of the gel material in a working battery was confirmed by completing multiple charge/discharge cycles over a range of representative charge paradigms. Each configuration was charged and discharged four times at the C/20 rate (full charge in twenty hours), four times at the C/10 rate (full charge in ten hours), and four times at the 1 C rate (full charge in one hour). The 1 C rate is considered to be an aggressive testing condition that is used to assess the stability of a battery under atypical use. It is understood that during charging the NaYF gel releases ions to the electrolyte, while during discharge the NaYF gel captures ions from the electrolyte. In some cases, a 1 C charging rate was applied using a current of 0.1 mA. The C/10 and C/20 rates were estimated using a theoretical capacity of one ion recting with one NaYF molecule. Current estimates were modified based on experimental validation. In an illustrative example, the specific charge capacity of NaYF gels for reaction with lithium ions was estimated at approximately 142 mAh/g, permitting C/20 and C/10 rates to be estimated based on the mass of NaYF gel.

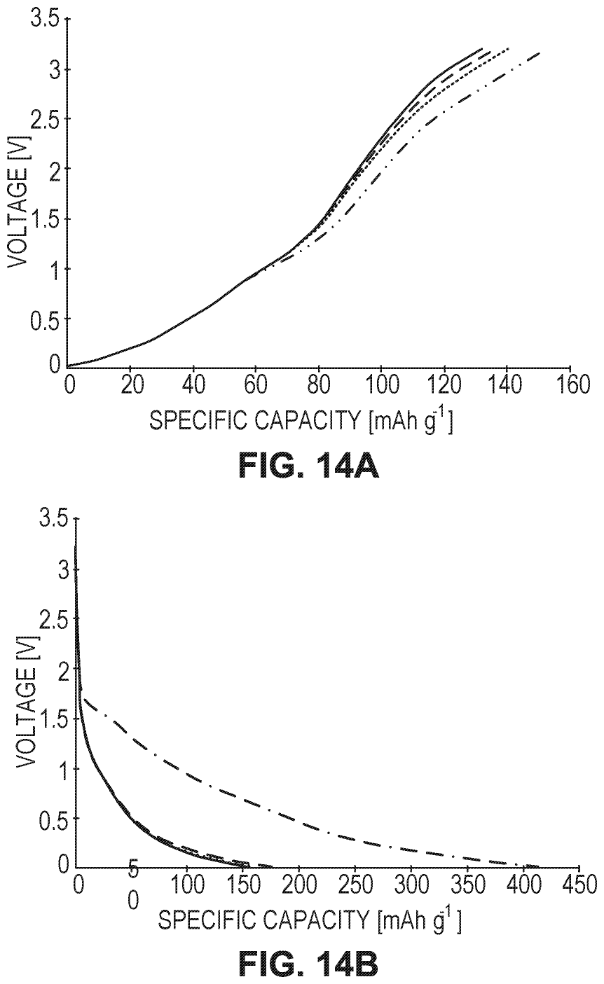

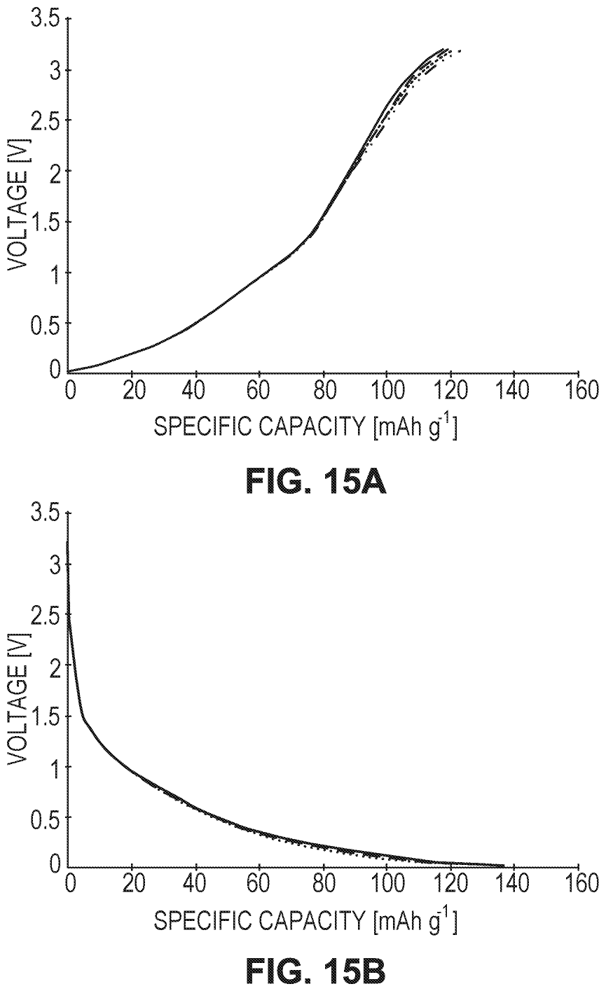

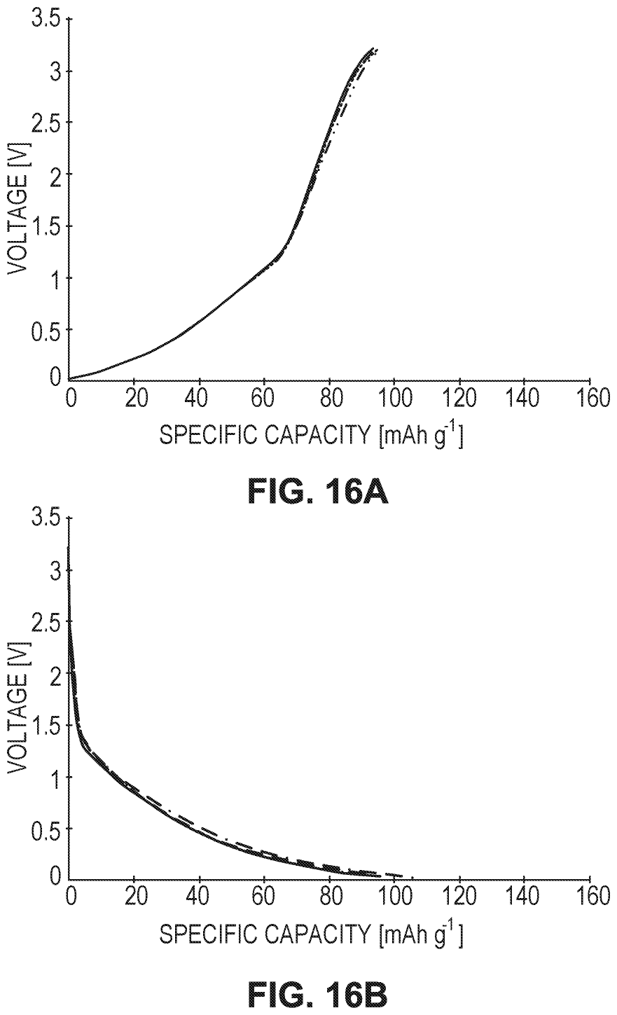

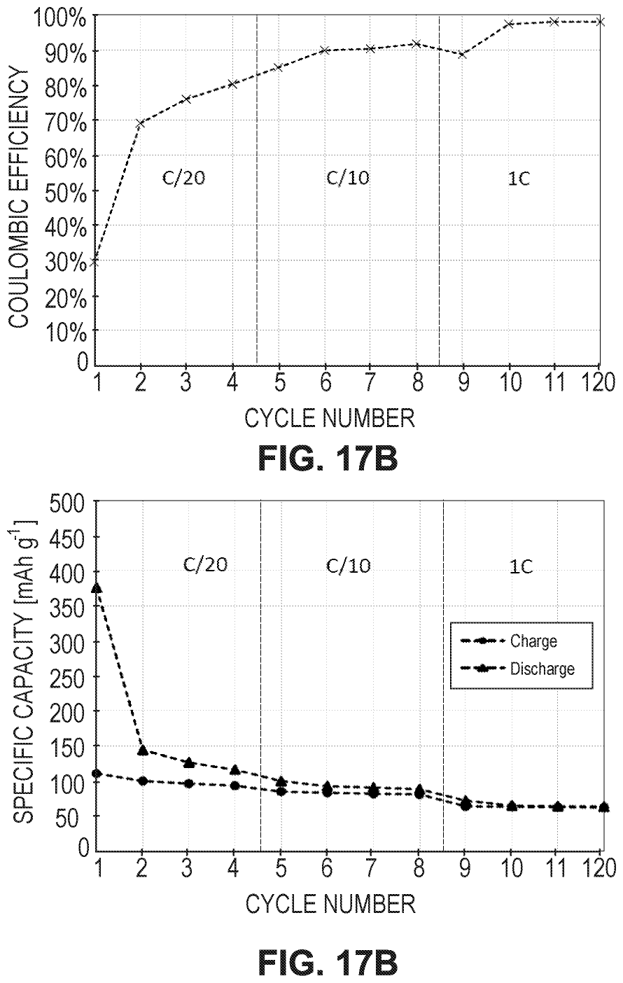

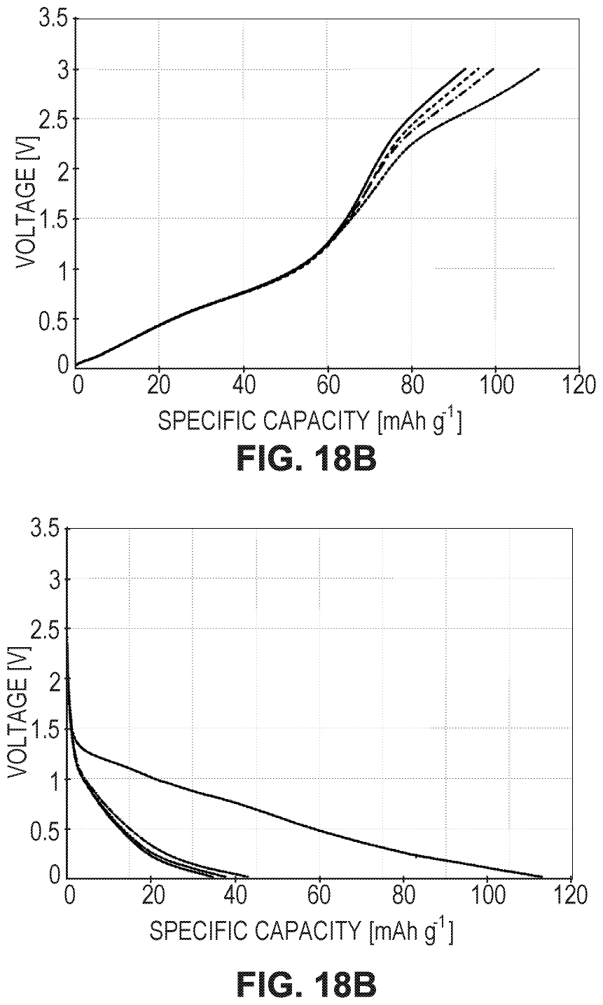

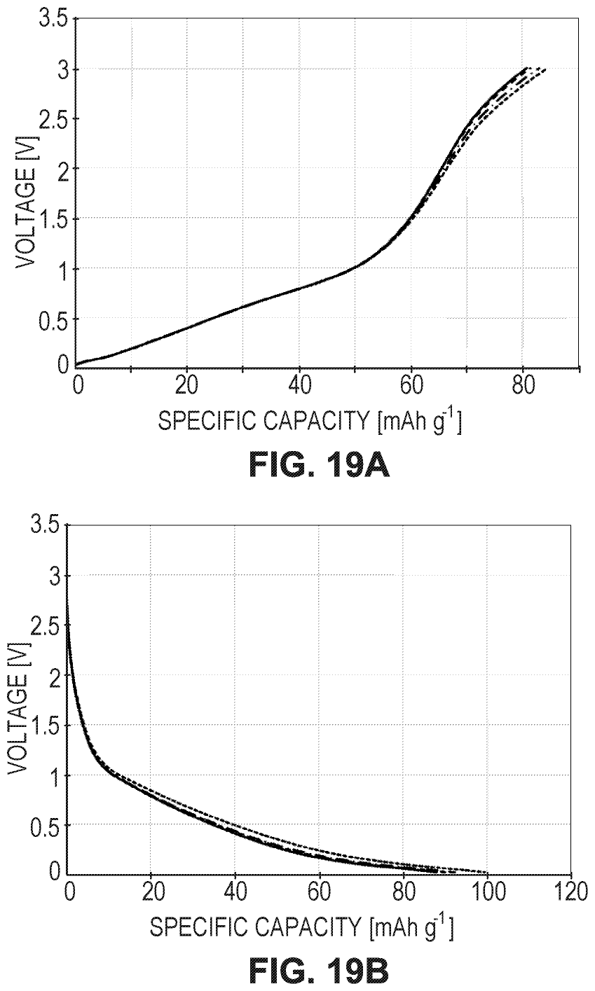

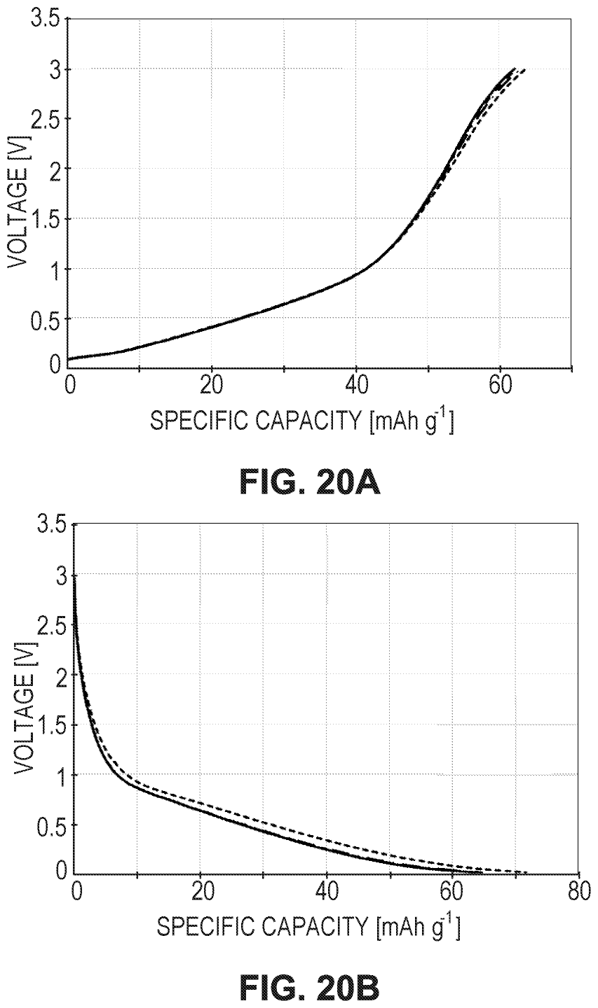

As illustrated in FIGS. 14-20B, batteries using NaYF gel charge storage media reversibly stored and discharged cationic charge carriers under all three charge/discharge paradigms tested, for a total of 24 charge/discharge cycles for both sodium ion and lithium-ion batteries. Data for lithium-ion batteries are provided in FIGS. 14-16B. Data for sodium-ion batteries are provided in FIGS. 17A-20B.

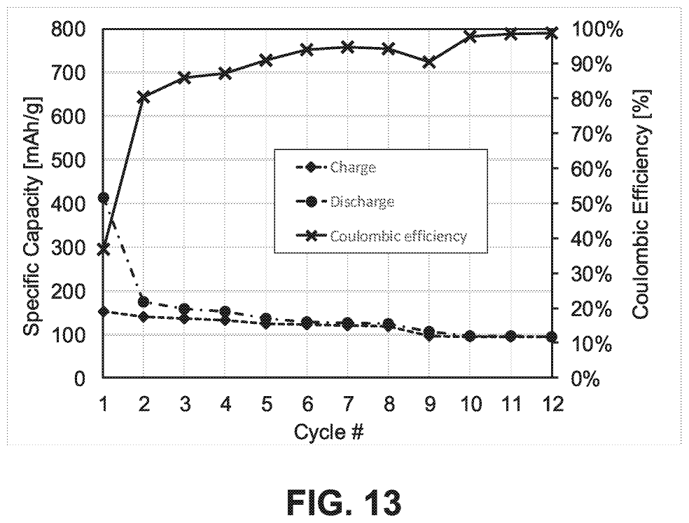

Under the 1 C charge/discharge paradigm, coin cells retained a coulombic efficiency greater than 90% (FIG. 13 for lithium-ion batteries and FIG. 17A for sodium-ion batteries). Coulombic efficiency, in this context, refers to the charge efficiency by which electrons are transferred in batteries, described by the ratio of the total charge extracted from the battery to the total charge put into the battery over a full cycle. Furthermore, specific capacity of the experimental batteries did not exhibit significant variation over the cycles tested (FIG. 13 for lithium-ion batteries and FIG. 17B for sodium-ion batteries). Specific capacity, in this context, refers to the charge capacity of the battery in milliamp-hours per gram of electrode material

With the exception of the first discharge cycle for each battery type, specific capacity for charge and discharge cycles did not vary between cycles by more than ten percent. The nominal specific capacity value decreased when the charge/discharge rate was increased (e.g., between C/20 and C/10, or between C/10 and 1 C) but between cycles the specific capacity was stable. Without being bound to a particular chemical mechanism, it is believed that the disparate behavior for the first discharge cycle is a result of the formation of a passivation layer on at least a portion of the porous electrode surface.

### Conclusion

Nanostructured NaYF gels performed as charge storage media in lithium ion and sodium ion batteries over multiple charge/discharge cycles and multiple different charge/discharge rates. Coulombic efficiency improved with each charge discharge cycle, and specific capacity measurements did not exhibit significant drift within charge/discharge rate tests, after a likely initial passivation process. Overall, the potential application of α-cubic NaYF nanostructured gels in energy storage devices including lithium-ion batteries and sodium-ion batteries was experimentally confirmed.

### Aspects of the Present Disclosure

The following aspects are provided as non-limiting embodiments of the present disclosure. Each embodiment is understood to include elements of the other aspects where appropriate.

In a first aspect, a nanostructured gel includes a primary crystalline phase including cubic sodium yttrium fluoride, a secondary crystalline phase including cubic yttrium fluoride, and an amorphous phase including sodium ions and yttrium fluoride.

In a second aspect, the nanostructured gel of the first aspect can be substantially free of organic solvents, capping ligands, or counterions.

In a third aspect, the nanostructured gel of any of the preceding aspects can include cubic sodium yttrium fluoride that is characterized by a nonstoichiometric composition NaₓY_{y}F_{z}. x can be a number in the range of 0-1, y can be a number in the range of 0-1, and z can be a number in the range of 0-4.

In a fourth aspect, the nanostructured gel of any of the preceding aspects can include cubic sodium yttrium fluoride that is characterized by a composition Na_{(0.5-x)}Y_{(0.5+x)}F_{(2+2X)}, wherein x is a number in the range of 0-0.5.

In a fifth aspect, the nanostructured gel of any of the preceding aspects can include a plurality of gel particles, aggregated to form an open-cell porous structure. The open-cell porous structure can include a first plurality of pores having a first characteristic dimension in the range of 50 nm-400 nm and a second plurality of pores having a second characteristic dimension in the range of 0 nm-50 nm.

In a sixth aspect, the nanostructured gel of any of the preceding aspects can include the open-cell porous structure that can be characterized by a specific surface area in the range of 5-200 m²/g.

In a seventh aspect, the nanostructured gel of any of the preceding aspects can include a lanthanide dopant.

In an eighth aspect, the nanostructured gel of any of the preceding aspects can act as an upconverting material when exposed to incident photons in the infrared range.

In a ninth aspect, the nanostructured gel of any of the preceding aspects can absorb heat when exposed to the incident photons.

In a tenth aspect, an antireflective structure includes a transparent substrate and the nanostructured gel of any of the preceding aspects overlying the substrate.

In an eleventh aspect, the antireflective structure of the tenth aspect includes the nanostructured gel that is characterized by a first index of refraction between 1.0 and a second index of refraction of the visibly transparent substrate.

In a twelfth aspect, the antireflective structure of any preceding aspect further comprises an encapsulation layer overlying the nanostructured gel, wherein the encapsulation layer is characterized by a third index of refraction between 1.0 and the first index of refraction.

In a thirteenth aspect, the encapsulation layer can be substantially impermeable to water, water vapor, liquid water, or the like. In this context, substantially impermeable can refer to a nonzero permeability that does not impair material, chemical, physical, or other properties of the nanostructured gel of any of the preceding aspects.

In a fourteenth aspect, the antireflective structure of any preceding aspect includes a nanostructured gel that further comprises a lanthanide dopant, and absorbs heat when exposed to incident photons in the infrared range.

In a fifteenth aspect, the antireflective structure of any preceding aspect includes a nanostructured ionic gel that is substantially free of organic solvents, capping ligands, or counterions.

In a sixteenth aspect, the nanostructured gel of any preceding aspect is formed by a process comprising combining a first aqueous solution of sodium fluoride with a second aqueous solution of yttrium chloride at ambient temperature and pressure to form a combined solution; and dewatering the combined solution to form the nanostructured gel of any of the preceding aspects.

In a seventeenth aspect, the process further comprises spin coating the nanostructured gel on a transparent substrate.

In an eighteenth aspect, the combined solution is substantially free of organic solvents, capping ligands, or counterions.

In a nineteenth aspect, the first aqueous solution or the second aqueous solution further can include a lanthanide salt.

In a twentieth aspect, the lanthanide salt can include ytterbium ions.

In a twenty-first aspect, an energy storage device includes a working electrode, configured to reversibly store a charge carrier; a counter electrode; a separator interposed between the working electrode and the counter electrode; and an electrolyte disposed between the working electrode and the counter electrode and contacting the working electrode, forming at least a part of a conductive path for the charge carrier between the working electrode and the counter electrode, wherein the working electrode comprises a nanostructured gel of any of the preceding aspects.

In a twenty-second aspect, the working electrode of any of the preceding aspects can further include a conductive additive and a binder, and wherein the nanostructured gel is pulverized and blended with the conductive additive and the binder.

In a twenty-third aspect, the charge carrier of any of the preceding aspects can be or include a fluoride ion, a lithium ion, and/or a sodium ion.

1. A nanostructured gel, comprising:
a primary crystalline phase including cubic sodium yttrium fluoride;
a secondary crystalline phase including cubic yttrium fluoride; and
an amorphous phase including sodium ions and yttrium fluoride.

2. The nanostructured gel of claim 1, wherein the nanostructured gel is substantially free of organic solvents, capping ligands, or counterions.

3. The nanostructured gel of claim 1, wherein the cubic sodium yttrium fluoride is characterized by nonstoichiometric composition NaₓY_{y}F_{z}, and wherein:
x is a number in the range of 0-1;
y is a number in the range of 0-1; and
z is a number in the range of 0-4.

4. The nanostructured of claim 3, wherein the cubic sodium yttrium fluoride is characterized by composition Na_{(0.5-x)}Y_{(0.5+x)}F_{(2+2X)}, wherein x is a number in the range of 0-0.5.

5. The nanostructured gel of claim 1, wherein the nanostructured gel comprises a plurality of gel particles, aggregated to form an open-cell porous structure including:
a first plurality of pores having a first characteristic dimension in the range of about 50 nm to about 400 nm; and
a second plurality of pores having a second characteristic dimension in the range of about 0 nm to about 50 nm.

6. The nanostructured gel of claim 5, wherein the open-cell porous structure is characterized by a specific surface area in the range of 50-200 m²/g.

7. The nanostructured gel of claim 1, further comprising a lanthanide dopant.

8. The nanostructured gel of claim 7, wherein the nanostructured gel acts as an upconverting material when exposed to incident photons in the infrared range.

9. The nanostructured gel of claim 7, wherein the nanostructured gel absorbs heat when exposed to the incident photons.

10. An antireflective structure, comprising:
a transparent substrate; and
a film overlying the substrate comprising a nanostructured gel.

11. (canceled)

12. The antireflective structure of claim 10, further comprising an encapsulation layer overlying the nanostructured gel, wherein the encapsulation layer is substantially impermeable to water molecules.

13. The antireflective structure of claim 10, wherein the nanostructured gel further comprises a lanthanide dopant, and absorbs heat from the transparent substrate when exposed to incident photons in the infrared range.

14. The antireflective structure of claim 10, wherein the nanostructured gel is substantially free of organic solvents, capping ligands, or counterions.

15. (canceled)

16. The antireflective structure of claim 10, wherein the film has a thickness from about 200 nm to about 400 nm.

17. A nanostructured gel formed by a process comprising:
combining a first aqueous solution of sodium fluoride with a second aqueous solution of yttrium chloride at ambient temperature and pressure to form a combined solution; and
dewatering the combined solution to form the nanostructured gel of claim 1.

18-24. (canceled)

19. An energy storage device, comprising:
a working electrode, configured to reversibly store a charge carrier;
a counter electrode;
a separator interposed between the working electrode and the counter electrode; and
an electrolyte disposed between the working electrode and the counter electrode and contacting the working electrode, forming at least a part of a conductive path for the charge carrier between the working electrode and the counter electrode,
wherein the working electrode comprises a nanostructured gel of claim 1.

20. The energy storage device of claim 25, wherein the nanostructured gel is substantially free of organic solvents, capping ligands, or counterions.

21-30. (canceled)

22. The energy storage device gel of claim 25, wherein the working electrode further comprises a conductive additive and a binder, and wherein the nanostructured gel is pulverized and blended with the conductive additive and the binder.

23. The energy storage device gel of claim 25, wherein the charge carrier is a fluoride ion.

24-34. (canceled)
